(19) United States
(12) Patent Application Publication
(10) Pub. No.: US 2009/0202700 A1
(43) Pub. Date: Aug. 13, 2009

(54) Nutritious snack products

(76) Inventors: Paul Ralph Bunke, Cincinnati, OH (US); Athula Ekanayake, Cincinnati, OH (US); Robert Lawrence Prosise, Cincinnati, OH (US); Peter Yen-Chih Lin, Cincinnati, OH (US); Gary James Dechert, Fairfield, OH (US); Sharon Lee Schnur, Fairfield, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/228,238

(22) Filed: Aug. 11, 2008

Related U.S. Application Data
(60) Provisional application No. 60/965,064, filed on Aug. 16, 2007.

(51) Int. Cl. A21D 8/02; A23L 1/29

(52) U.S. Cl. 426/549; 426/615

(57) ABSTRACT

Snacks are provided that contains fruit or vegetable materials. Snacks can be formulated to provide one half of a serving and up to and including at least one serving, and fractions therebetween, of fruit or vegetable in a single 28 gram serving of snack. The snacks can comprise 12% or less fat. A fruit snack can comprise from about 12% to about 66% of fruit source solids; from about 34% to about 88% of starch; from about 0.1% to about 5.0% of water; and from about 0% to about 54% of optional ingredients.

### CROSS REFERENCE TO RELATED APPLICATIONS

This application claims priority to and the benefit of U.S. Provisional application 60/965,064, filed on Aug. 16, 2007, which is hereby incorporated by reference herein in its entirety.

### FIELD

The present invention relates to snack products and more particularly to nutritious snack chips.

### BACKGROUND

Fabricated snack products prepared from dough comprising starch-based materials are well-known in the art. Potato based dough, and the snacks made therefrom, are especially well known. These doughs are typically fried in oil or baked to form the snack chip. Consumers are, however, looking for snack products that contain healthful ingredients other than starch materials. Moreover, consumers have demanded better flavor and nutrition in snack chips. While all age groups eat snacks, children are heavy consumers of these products, and it would be highly desirable if children could get more nutrition from a snack product that they enjoy eating. Even more desirable would be to produce a good tasting snack product without artificial flavors and preservatives. Even more preferred would be a snack product that can provide a full or half serving of fruit, vegetables, or dairy (as defined in the USDA Food Guide Pyramid) in a serving, especially if the snack were low fat and had less than 125 calories.

For example, consumers like to have fruit and vegetable based snacks. Fruit and many vegetables, as well as the dehydrated forms of these materials, typically contain high levels of sugar and moisture. Snacks made from these products tend to burn when cooked and develop off flavors, particularly during frying, baking, extrusion, and other thermal processing. Also, fruit and vegetable ingredient manufacturers usually pre-treat the initial products with preservatives such as sulfur dioxide, bisulfite materials, or organic acids, such as ascorbic or citric acid, in order to extend the shelf life of these materials. These preservatives can promote discoloration of the fruit or vegetable and increase the browning reactions during cooking and other processing steps. Moreover, these ingredients are unacceptable in natural products and those that claim to be “preservative free.” For these reasons, fruit based snack products that are fried or cooked have proven difficult to make in a consumer acceptable format.

Likewise, meats, cheeses, nuts, fish, whole grains, eggs, and other nutritional foods are equally desirable for use in snack foods, but they are also hard to formulate in a consumer acceptable snack product. The oil content, as well as protein or fiber content, present a challenge in formulation.

The relatively high temperatures and cooking times necessary to produce a thin, crisp snack product degrade the flavor of these nutritional additives such as, fruits, vegetables, meat, cheese, fish, and the like. The nutritional value of these materials is often degraded during the cooking process as well, particularly when extrusion or steaming is used during processing. Thus, commercially available snack chips fabricated from fresh fruit, vegetables, and the like lack the “authentic flavor” and nutritional value of the main ingredient.

“Authentic flavor” as used herein refers to consumer recognition of the flavor as the flavor of the nutritional component, such as, apple, tomato, carrot, shrimp, tuna, or even combined flavors as salsa or pizza. For example, the flavor of a fabricated apple chip should taste like a fresh apple without the addition of artificial apple flavor. Likewise, a corn or shrimp based chip should taste like cooked corn or shrimp without the addition of artificial flavors.

Many reasons exist for the degradation of the natural flavor and nutritional value in fabricated snack chips comprising fruits, vegetables, meats, cheeses, nuts, fish, whole grains, eggs, and the like. Many of these products are high in moisture content, especially fresh fruit. But snack chips, even those made with fruit, must be low in moisture content so that they are crisp and so that they maintain shelf stability without preservatives. While the water content of the dough can be controlled to some extent, the total moisture content of the snack product must be lowered. This dehydration is usually done by steaming, baking, or frying. If the snack chip is to be fried in hot oil, as most are, the dough must be relatively low in oil or fat before frying to remain low in total fat content as well as to meet the desired caloric content.

The binder in a fabricated chip is typically a starch material that is pre-gelled or heated as part of the processing. For example, shrimp chips are very popular in many countries. The comminuted shrimp is typically mixed with a bland starch material, for example, rice, and then the dough is cooked at high temperatures to gelatinize the starch and cook the shrimp. This first step has a negative effect on the authenticity of the shrimp flavor and may degrade some of the nutrients as well. The dough is then dried into a “half-baked” product, which is shelf stable. This drying can also be detrimental to the remaining flavor and nutrition of the product. Finally, the half-baked product is cooked by frying, baking, microwaving, or the like, to make a crisp snack product.

In the past, the addition of pieces of the nutritional food ingredients into a starch based dough, for example, pieces of fruit, vegetable, meat, cheese and the like, resulted in a product with burnt pieces of the additive and often off-flavors. These products did not taste good and sometimes had dark or burnt specks.

Moreover, snacks that are formulated with high concentrations of non-starch ingredients have different textures in the finished product. The texture of the snack is a function of the temperature at which a glassy structure is obtained. The higher the glass transition temperature of the starch, the crispier the texture would be. Depending on the non-starch ingredient used, the dough can be sticky and weak with low glass transition temperatures, which are difficult to process (sheeting, cutting, and frying). Ultimately, when this type of dough is cooked, the resulting snack is not crisp and often becomes stale quickly. Hence, a need exists for formulae, doughs, and processes for making fabricated snack products with relatively high concentrations of non-starch ingredients, for example, fruits, vegetables, meats, cheeses, nuts, fish, whole grains, eggs, and the like, while maintaining certain textural and taste qualities that consumers prefer. A need also exists for a fruit containing snack product that is formed from a dough, and then fried or partially fried, and then baked, or just baked, that consumers perceive as having a positive

These and other advantages of embodiments of the invention will become apparent from the following disclosure.

### SUMMARY

A snack chip comprising fruit source solids or vegetable source solids and wherein the snack chip comprises less than about 12% fat is disclosed. A plurality of snack chips is also disclosed. A plurality can provide at least one half of a serving of fruit or at least one half of a serving of vegetable. The snack chip can have a water absorption value of less than 2.5. The snack chip can be made by combining dry ingredients with water to form a dough; sheeting the dough; cutting the dough into pieces; drying the pieces into a half product; baking the half product into the snack chip.

A snack comprising from about 12% to about 66% of fruit source solids; from about 34% to about 88% of starch material; from about 0.1% to about 5.0% of water; and from about 0% to about 54% of optional ingredients is also disclosed. The snack chip can comprise less than 12% fat.

A dough for use in preparing a snack chip comprising from about 20% to about 81% of fruit puree; from about 15% to about 50% pre-gelatinized starch material; from about 0% to about 65% optional ingredients is also disclosed.

A method for making a snack chip comprising forming a dough by mixing: 7% to 50% of fruit source solids; 12% to 50% of pre-gelatinized starch material; and 0% to 81% of optional ingredients; forming the dough into a thin sheet; forming the thin sheet into a snack chip; and drying the snack chip to a moisture content of between about 0.3% and 3% is also disclosed.

A packaging system comprising a package defining an interior volume and having an outer panel visible to a consumer while in a customary position on a retail store shelf; a product contained within the package; a label displayed on the panel, wherein the label comprises a first statement that at least one full serving of fruit or vegetable is delivered by one full serving of the product contained within the package, a second statement located on the package that defines one full serving of the product; wherein the product contained within the package comprises a plurality of fabricated snack chips comprising at least one full serving of fruit or vegetable per one full serving of fabricated snack chips as defined by the label is also disclosed.

Also disclosed is a packaging system comprising a package defining an interior volume and having an outer panel visible to a consumer while in a customary position on a retail store shelf; a product contained within the package; an ingredient list displayed on the panel wherein the ingredient list comprises a listing of ingredients of the product contained within the package; wherein the first ingredient of the ingredient list is selecting from the group consisting of a fruit, a vegetable, a fruit puree, and a vegetable puree; wherein the product within the package comprises a plurality of fabricated snack chips that have as their most predominant ingredient an ingredient selected from the group consisting of a fruit, a vegetable, a fruit puree, a vegetable puree, and combinations and mixtures of these.

A kit is also disclosed. The kit can comprise a package comprising a label displayed on the package, wherein the label comprises a first statement that at least one full serving of fruit or vegetable is delivered by one full serving of a product contained therein; a second statement located on the package that defines one full serving of the product; wherein the package further comprises an ingredient list displayed on the panel, wherein the ingredient list comprises a listing of ingredients of the product contained therein, wherein the first ingredient of the ingredient list is a fruit or a vegetable; wherein the product comprises a plurality of fabricated snack chips contained within the package, wherein the fabricated snack chips comprise at least one full serving of fruit or vegetable per one full serving of fabricated snack chips and wherein the fabricated snack chips have as their most predominant ingredient an ingredient a fruit or a vegetable.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 is a graph of Snack Crumb Absorption versus Percent Fat.

FIG. 2 is a table of data for the commercial tested products graphed on FIG. 1.

FIG. 3 is a Nutritional Index Rank of Snack Foods.

FIG. 4 is the ranking index information for the ranks indicated in FIG. 3.

FIG. 5 is a graph of the drying process showing the percent moisture over time.

FIG. 6 is a picture of one embodiment of a snack food.

FIG. 7 is a picture of one embodiment of a snack food.

FIG. 8 is a picture of one embodiment of a snack food.

### DETAILED DESCRIPTION

A. DEFINITIONS

As used herein, “gelatinized starch” includes any type of starch or flour that has been treated to gelatinize the starch. Native or uncooked starches that are found in nature are generally insoluble in water. Processed or commercial starches have had most of the moisture removed, and they are generally insoluble in water. As starch and water are heated, the grains or granules absorb water. Generally, up to 50° C. , this absorption is reversible. However as heating is continued, the swelling of the granule is irreversible, gelatinization begins. The gelatinization temperature range is dependent on the starch. Gelatinization is usually evidenced by increased translucency of the starch and increased viscosity of the solution. Starch granules also lose their birefringence when gelatinized.

Gelatinized starches as used herein include fully gelatinized, partially gelatinized, and pre-gelatinized starches. Gelatinized starches can include, but are not limited to, those which have been treated by parboiling, cooking, partially cooking, and extruded flours.

As used herein, “pre-gelatinized” means the starch has been treated to gelatinize it. Commercially available pre-gelatinized starch is usually sold as a dry powder. As practiced in embodiments of the present invention, pre-gelatinizing can be done before the starch is used to make the dough.

As used herein, a “fruit” can refer to any product that is generally referred by the public as a fruit and can include an apple, apricot, avocado, banana, blueberry, blackberry, carambola, carrot, cherry, cranberry, date, elderberry, fig, guava, gooseberry, grapefruit, grapes, kiwi, kumquat, lemon, lime, lychee, mango, melon—cantaloupe, melon—red water, olive, orange, papaya, passion fruit, peach, pear, persimmon, pineapple, pomegranate, plum, raspberry, star fruit, strawberry, tangerine, and combinations and mixtures thereof.

As used herein, a “vegetable” can refer to any product that is generally referred by the public as a vegetable and can include artichoke, asparagus, beans (green, baked, pinto, black, etc.), beets, broccoli, Brussels sprouts, cabbage, carrot, cauliflower, celery, chick pea, corn, cucumber, eggplant, garlic, gourd, leek, lettuce, mustard, onion, peas, pepper, potato, pumpkin, spinach, squash, turnips, yam, zucchini, and combinations and mixtures thereof.

As used herein, “dehydrated fruit materials” refers to raw fruit materials or any intermediate source of fruit with a moisture content below 15%. Examples are fruit based flour, fruit based pellets, extruded fruit products, dried fruit pieces, vacuum dried fruit pieces, air puffed fruit containing pieces, and combinations and mixtures thereof.

As used herein, “dehydrated vegetable materials” refers to raw vegetable materials or any intermediate source of vegetable with a moisture content below 15%. Examples are vegetable based flour, vegetable based pellets, extruded vegetable products, dried vegetable pieces, vacuum dried vegetable pieces, air puffed vegetable containing pieces, and combinations and mixtures thereof.

As used herein, “puree” is used in its conventional meaning and can be derived from fruit, vegetable, meat, or any other material meant for consumption that comprises moisture. A fruit puree can be a paste or thick liquid suspension made from finely ground fruit. Purees can comprise added water or other liquid that was used to extract fruit soluble solids. Purees can also be concentrated or condensed to varying levels by removal of water as practiced by some suppliers.

As used herein, “fruit source solids” refers to dehydrated fruit materials, powders, and purees minus their water content. The dry solids include both soluble solids, non-limiting examples of which include sugars, and insoluble solids, non-limiting examples of which include fiber.

As used herein, “vegetable source solids” refers to dehydrated vegetable materials, powders, and purees minus their water content. The dry solids include both soluble solids, non-limiting examples of which include sugars, and insoluble solids, non-limiting examples of which include fiber.

As used herein, “nutritional additives” refers to any food that is part of the USDA Food Guide Pyramid. These include fruits, vegetables, proteins or meats, dairy products, fats, and grains. Fiber enriched foods are also nutritional additives. These nutritional additives may be dehydrated to a moisture content of less than about 15%.

As used herein, “fabricated” refers to food products made from doughs comprising purees, flour, meal, and/or starch, such as those derived from tubers, grains, legumes, cereals, or combinations and mixtures thereof. For example, a potato chip that is prepared by frying a portion of a potato is not fabricated, but a potato chip made of potato flakes and starch made into a dough piece that is fried is a fabricated potato chip.

As used herein, “native starch” refers to starch that has not been pre-treated or cooked in any way, and includes but is not limited to hybrid starches.

As used herein, “dehydrated potato products” includes, but is not limited to, potato flakes, potato flanules, potato granules, potato agglomerates, any other dehydrated potato material, and combinations and mixtures thereof.

As used herein, “sheetable dough” is cohesive dough capable of being placed on a smooth surface and rolled or otherwise flattened to a desired final thickness without tearing or forming holes. Sheetable dough can also include dough that is capable of being formed into a sheet by rolling or pressing between two belts or through a low work, low temperature process.

As used herein, “starch” or “starch materials” refers to a native or an unmodified carbohydrate polymer containing both amylose and/or amylopectin. It is derived from legumes, grain, tubers, roots, or pith such as, but not limited to, wheat, corn, tapioca, sago, rice, potato, oat, barley, and amaranth. Starch as used herein also refers to modified starch including but not limited to hydrolyzed starches such as dextrins, maltodextrins, high amylose corn, high amylopectin corn, pure amylose, chemically substituted starches, crosslinked starches, and other modifications including but not limited to chemical, physical, thermal or enzymatic, and combinations and mixtures thereof.

As used herein, “starch-based flour” refers to a flour having high levels of starch that is derived from a starch based food material and is in either natural, dehydrated (e.g., flakes, granules, meal), or flour form. Starch-based flour can include, but is not limited to, potato flour, potato granules, potato flanules, potato flakes, corn flour, masa corn flour, corn grits, corn meal, rice flour, buckwheat flour, oat flour, bean flour, barley flour, tapioca, and combinations and mixtures thereof. For example, the starch-based flour can be derived from tubers, legumes, grain, roots, pith, or combinations and mixtures thereof. Starch or starch materials can also refer to starch-based flour.

As used herein, “emulsifier” refers to emulsifier that has been added to the dough. Emulsifiers that are inherently present in the dough ingredients, such as in the case of the potato flakes (where emulsifier is used as a processing aid during manufacturing), are not included in the term “emulsifier.”

The terms “fat” and “oil” are used interchangeably herein unless otherwise specified. The terms “fat” or “oil” refer to edible fatty substances in a general sense, including natural or synthetic fats and oils consisting essentially of triglycerides, such as, for example soybean oil, corn oil, cottonseed oil, sunflower oil, palm oil, coconut oil, canola oil, fish oil, lard and tallow, which may have been partially or completely hydrogenated or modified otherwise, as well as non-toxic fatty materials having properties similar to triglycerides, herein referred to as non-digestible fats, which materials may be partially or fully indigestible. Reduced calorie fats and edible non-digestible fats, oils or fat substitutes are also included in the term.

As used herein, “non-digestible fat” refers to those edible fatty materials that are partially or totally indigestible, e.g., polyol fatty acid polyesters, such as OLEAN . Non-limiting examples of non-digestible fats can include are fatty materials having properties similar to triglycerides, such as sucrose polyesters. These non-digestible fats are described in U.S. Pat. No. 5,085,884, issued Feb. 4, 1992 to Young et al. and U.S. Pat. No. 5,422,131, issued Jun. 6, 1995 to Elsen et al. A brand of non-digestible fats is sold under the trade name OLEAN™.

By the term “dry blend” it is meant herein the dry raw material mixed together prior to processing of the materials so mixed.

By the term “variegated” it is meant a diversity or variety in character, appearance, or flavor, typified by visual colored markings such as spots, streaks, etc.

By the term “split-dough” it is meant that a given dough formulation is subdivided into at least two separate dough formulas so that one or more ingredients can be concentrated within one of the doughs, and where the separate doughs can be prepared individually. Upon commingling of the dough's, followed by sheeting of said commingled dough, a variegated chip can be produced.

It should be understood that wherever the term “fruit” is used within this disclosure as describing a type of ingredient being used or chip being made, the term “vegetable” could equally be used. For example only, many embodiments disclose using a fruit puree. A vegetable puree could equally be used. Also, for example only, many embodiments describe a fruit snack. A vegetable snack could equally be described.

All percentages are by weight unless otherwise specified.

B. SNACK CHIPS

Embodiments of the present invention can deliver a snack that has a high concentration of dehydrated and optionally non-dehydrated or fresh nutritional ingredients. Snacks can be formulated to provide one half of a serving and up to and including at least one serving, and fractions therebetween, of fruit, vegetable, or dairy in a single 28 gram serving, or per one serving, of snack. These snacks can also contain less than 125 calories per serving. As used herein, a serving of fruit, vegetable, dairy, or any other ingredient is a serving as defined by the governing body. For example, in the United States, the governing body for defining a serving of fruit is the United States Department of Agriculture (USDA). Snacks of some embodiments can also deliver, for example, fruits, vegetables, meats, cheeses, nuts, fish, whole grains, eggs, and the like, in a snack that provides a natural flavor and a nutritional benefit from the ingredients. Moreover, the nutritional snacks of some embodiments of the present invention can be formulated without a need for added flavors, wherein the added flavors would mimic the main natural ingredient. The snacks can have a crispy and crunchy texture and appealing appearance to consumers. Further, the dough and snacks made therefrom can be low in off-flavors.

As described herein, one half of a serving and up to and including at least one serving, and fractions therebetween, of fruit or vegetable can be provided by embodiments of the present invention. It should be understood, and is described in detail in section 7 of the Analytical Methods section, that the amounts of fruit or vegetable used can vary based on the level of serving being provided by the snack chip and based on the solids needed to be provided based on the USDA definition for a serving of the fruit or vegetable. For example, the amount of apple solids needed for one serving is less than the solids needed for a banana because an apple generally has a higher water content. Thus, it should be understood that those variations are taken into account in the ranges as disclosed herein, and thus all fractions therebetween are within this disclosure as they are dependent on the amount of serving being provided by the snack chip and the type of fruit or vegetable being provided.

Regarding cheese & nuts, the USDA has set a serving of cheese as 1.5 ounces. Cheeses may range from about 40% to about 70% solids, and these amounts would need to be used in accordance with the methods herein in arriving at a chip comprising a full serving, a half serving, fractions therebetween, or less per serving of snack chip.

The USDA also has set one ounce of nuts as equivalent to two ounces of meat, for substitution purposes in the meats and beans group. Two to three ounces of meat is considered one serving. By inference, one serving of nuts then can be considered to be between 1 and 1/0.5 ounces. Therefore, based on the raw weight of a specific nut, and taking into account the water content thereof, a full serving, half serving, or fractions therebetween or less can be calculated for inclusion into one serving of snack chip.

“Fabricated snack,” “snack,” “snack chip,” “snack product,”, “fruit product” “fruit snack,” and “crisp” are used interchangeably throughout and mean, along with any other definition provided herein, a product consumable by humans and other animals. Non-limiting examples include products such as breads, crackers, fried snacks, fruit and vegetable snacks, baked or dried snacks, baby foods, dog foods, dog biscuits, and any other suitable food product.

In one non-limiting example, a method for making a snack chip is disclosed. The method can comprise:
a) providing a fruit source solids;
b) providing a pre-gelatinized starch material;
c) forming a dough by mixing by weight 7% to 50% fruit source solids, 12% to 50% said pre-gelatinized starch material, and 0% to 81% optional ingredients;
d) forming said dough into a thin sheet;
e) forming a snack chip from said thin sheet.
f) drying said snack chip to a moisture content of between 0.3% and 3%.

In one non-limiting example of a snack made according to one type of fruit based embodiment of the present invention, the fruit snack can comprise:
a) from about 12% to about 66% of fruit source solids;
b) from about 0% to about 25% starch-based flour;
c) from about 34% to about 88% of starch, which starch can include tapioca, rice, and combinations and mixtures thereof;
d) from about 0.1% to about 5.0%, or from about 0.2% to about 4%, or from about 0.3% to about 3%, by weight, water; and
e) from about 0% to about 54% of optional ingredients.

The fruit snack can be formed from a dough. The dough can comprise:
a) from about 20% to about 81% of fruit puree;
b) from about 15% to about 50% pre-gelatinized starch material, which starch can include tapioca, rice, and combinations and mixtures thereof;
c) from about 0% to about 65% optional ingredients.

In one non-limiting example, a method for making a snack chip is disclosed. The method can comprise:
a) providing a vegetable source solids;
b) providing a pre-gelatinized starch material;
c) forming a dough by mixing by weight 2% to 58% vegetable source solids, 12% to 50% said pre-gelatinized starch material, 0% to 86% optional ingredient;
d) forming said dough into a thin sheet;
e) forming a snack chip from said thin sheet;
f) drying said snack chip to a moisture content of between about 0.3% and 3%.

In one non-limiting example of a snack made according to one type of vegetable based embodiment of the present invention, the vegetable snack can comprise:
a) from about 4% to about 66% of vegetable source solids;
b) from about 0% to about 25% oatmeal;
c) from about 14% to about 96% of starch materials, which starch can include tapioca, rice and mixtures thereof;
d) from about 0.1% to about 5.0%, or from about 0.2% to about 4%, or from about 0.3% to about 3%, by weight, water; and
e) from about 0% to about 82% of optional ingredients.

The present vegetable snacks can also be formed from dough. The dough can comprise:
a) from about 11% to about 85% of a vegetable puree;
b) from about 4% to about 45% pre-gelatinized starch material, which starch can include tapioca, rice and mixtures thereof;
c) from about 0% to about 85% optional ingredients.

In another embodiment, the snacks can be made by combining dry ingredients with water to form a dough, which is then sheeted. The sheeted dough can be cut into desirable shaped pieces and dried to form a fabricated snack product or dried to produce a “half product,” which is a shelf stable intermediate. For a half-product, the dough can be dried at a temperature of less than about 250 F. Half-products generally are shelf stable and can be stored and cooked later. The half-product can also be cooked immediately after the drying process to form a snack chip. Non-limiting examples of cooking include baking, frying in oil, vacuum baking or frying, microwaving, and combinations and mixtures thereof. The product can expand during this final cooking process to provide a snack chip having a crisp texture.

In another embodiment, the snacks can be made by combining a puree, such as a fruit puree, with starch material to form a dough, which is then sheeted. The sheeted dough can be cut into desirable shaped pieces and dried to form a fabricated snack product or “half product,” which is a shelf stable intermediate. In another embodiment, the sheet dough is baked to form a snack product, i.e., drying through the half product stage and directly baked to a final dried stage having from 1% to 3% moisture content. Mixing, forming, and drying can be done using low work input and drying temperatures below about 400° F.

In another aspect, the snack chip can be made by combining a nutritional additive and starch with water to form a sheetable dough. The dough can be mixed and sheeted without passing through a cooking extruder. The sheeted dough can be cut into desirable shaped pieces and cooked by baking at about 350 F for about 1 to 5 minutes and then allowed to continue baking at a lower temperature of about 225 F for about 10 additional minutes.

In yet another embodiment, the snacks can be made by first cooking a native starch material to gelatinize it, then cooling the starch down to below the gelatinizing temperature, adding the dried fruit material, forming a dough, and sheeting it. The sheeted dough can be cut into desirable shaped pieces and dried to form a fabricated snack product or “half product” that is a shelf stable intermediate.

In another embodiment, the half product can be cooked by baking, frying in oil, vacuum baking or frying, microwaving, and combinations and mixtures thereof to make the nutritional snack. The half product can expand during the final cooking to provide a crisp texture.

In yet another embodiment, the snacks can be made by first cooking a native starch material to gelatinize it, then cooling it down to below the gelatinizing temperature, adding the dried fruit material, forming a dough and sheeting it. The sheeted dough can be dried to form a fabricated snack product or “half product” which is a shelf stable intermediate.

C. FRUIT OR VEGETABLE MATERIAL

The fruit source solids can be selected from the group consisting of apple based flour, strawberry based flour, banana based flour, pear based flour, apricot based flour, cranberry based flour, any dry fruit, and combinations and mixtures thereof. The fruit source solids can include apple based flour, or other as recited herein, and can include pieces of fruit, for example apple pieces, or any other as recited herein, that can be added to the dough. The fruit source solids can be at least about 90% or more apple based flour. At least 70% or more of the apple cells can be intact.

The fruit materials can be dried to a moisture content no higher than 15%. Also, the fruit can be ground to a specific particle size distribution (from flour to agglomerates, pieces, extrudates and co-extrudates). The level of fruit source solids in the formula can vary from about 12% to about 66%, or from about 15% to about 40%, or from about 20% to about 35%, by weight of the dry ingredients.

The particle size of the dehydrated fruit material can be such that at least 75% of the particles pass through a 20 mesh screen.

The fruit materials can be supplemented or flavored with natural or artificial flavors, juices, purees, and the like. Other dehydrated fruit materials can be appropriate for use herein as described above. Examples of suitable fruit based flours, their source, and properties are given in Tables B1 and B2 below.

TABLE B1

| Material | Supplier | Location |
|---|---|---|
| Apple Powder low SO₂ | Surfrut | Santiago, Chile |
| Apple Powder | FDP USA, Inc. | Santa Rosa, CA. |
| Apple Powder | Agrocepia | Talca, Chile |
| Apple Powder without skin | Agrocepia | Talca, Chile |
| Fruit sensations (fruit flavored | Treetop | Selah, WA |
| intermediate moisture apple | | |
| dices) | | |
| Diced apple | Agrocepia | Talca, Chile |
| Apple Powder (sample treated | Agrocepia | Talca, Chile |
| with ascorbic acid) | | |
| Apple powder chop (with skin) | Treetop | Selah, WA |
| Apple powder | Treetop | Selah, WA |
| Banana Flakes | Confoco | Ecuador |
| Banana powder | Confoco | Ecuador |
| Strawberry flour | Mercer | Carmel, CA |

TABLE B2

| | Strawberry Flour | |
|---|---|---|
| | Mercer | Apple Flour |
| Proximate Analysis* | Processing, Inc. | Treetop, Selah, |
| (%) | Modesto, CA. | WA. |
| Water* | 3 | 2.8 |
| Sugars* | 41.3 | 69.2 |
| Protein* | 7.1 | 2.0 |
| Total Fat* | 4.3 | 0.3 |
| Total Carbohydrates* | 80.7 | 92.0 |
| Dietary Fiber* | 6.1 | 6.2 |
| Potassium (mg)* | 1,642.5 | 620 |
| Calcium (mg)* | 177.6 | 34 |
| Vitamin C (mg)* | 457.2 | 11.3 |
| Vitamin A (IU)* | 499.4 | 101.0 |
| Particle Size | 90% through | 90% through mesh |
| Distribution | mesh #20 | #20 |

*Information provided by suppliers

Fruit purees can also be used as a fruit source when making the dough. When purees are used, the size of the particles can be similar to that in the dehydrated particle distribution. Fruit purees also can be concentrated to varying levels by suppliers. When fruit puree is used, the added water content of the dough is adjusted to accommodate the water in the puree.

To maximize the benefits of adding fruit source solids to the fabricated snacks of some embodiments of the present invention, a starch material, can be included in the dough, non-limiting examples of which include those defined herein and including a rice based material, such as rice flour. The starch material, or rice based material, which can be extruded or precooked, along with optional starches, can aid in the expansion of the final snack chip.

D. STARCH MATERIALS

As discussed above, to maximize the benefits of the fruit source solids, the dough of some embodiments of the present invention can include from about 12%, to about 50% by weight of the snack chip of starch material. In one embodiment, the starch material can be tapioca. In one embodiment, the starch material can be tapioca starch or flour that has been cooked partially to provide for a relatively small proportion of broken cells and gelatinized starch granules leaving most of the cellular structures of the flour and the internal starch granules in their native form.

The starch material can help to create the authentic fruit flavor of the fruit snack. Moreover, rice and tapioca based starch provide a neutral and clean flavor allowing the fruit flavor to be recognized and be more apparent to the consumer. Rice and tapioca have naturally bland flavors that generally do not mask the fruit flavor like corn or potato flours can.

Further, at least about 40% of the starch material used in the snack chips of some embodiments of this invention can be pre-gelatinized. That is, at least a portion of the starch is cooked before adding the non-starch ingredients. Prior fabrications and formulae allowed for mixing the main ingredients and the starch and then cooking, that is, gelatinizing them both in-situ. In-situ gelatinization requires that the dough have very high moisture content or that moisture loss be controlled by pressure cooking or other methods know in the art. Regardless, the harsh conditions of in-situ gelatinization can tend to destroy flavor, and it is believed that the nutritional value of the non-starch ingredients can be degraded as well.

While not wanting to be bound by any one theory, it is believed that in-situ gelatinization with, for example, steam, breaks down the starch cells and frees up the amylose within the cells. The amylose may complex with flavor components resulting in a trapping of the flavor components. Moreover, in-situ gelatinization can cause the snack chip to be puffy and have unacceptable texture for consumers.

Pre-gelled starch materials serve also as processing and formulation additives that provide a better dough, resulting in a superior sheeted product from which the fabricated snack piece can be made.

Additional starch materials that can be used include, but are not limited to, conventional rice flour, conventional tapioca starch, pre-gelatinized starches, low viscosity starches (e.g., dextrins, acid-modified starches, oxidized starches, enzyme modified starches), stabilized starches (e.g., starch esters, starch ethers), waxy rice starch or flour, cross-linked starches, acetylated starches, starch sugars (e.g. glucose syrup, dextrose, isoglucose) and starches that have received a combination of treatments (e.g., cross-linking and gelatinization) and combinations and mixtures thereof. Those skilled in the art will appreciate that the starch materials described herein are commercially available, for example, from Remy Industries N.V., Remylaan 4, B-3018 Leuven-Wijgmaal, Belgium. The conventional rice flour can include long grain, medium grain, short grain and sweet or grain rice can all be made into rice flour. In addition, rice flour can be made from broken pieces or whole pieces of rice. Rice flours made from these different types of rice vary in water absorption index, peak viscosity, final viscosity, and total amylose content. Furthermore, if the rice is partially or fully pre-cooked, parboiled, or pre-gelatinized in any other way prior to, or after, processing into rice flour, the rice flour properties can be further modified.

Mixing together the desired quantities of various flours can be used to make the desired starch materials. This mixing can be accomplished by any suitable means such as, but not limited to, mixing the grains before milling, or mixing the flours together after milling.

In one embodiment, gelatinized tapioca flour can be used. In this embodiment, the composition can comprise a blend of one or more tapioca flours that have been gelatinized to varying degrees. For example, the gelatinized tapioca flour can comprise fully cooked tapioca, partially cooked tapioca, parboiled tapioca, extruded tapioca, or combinations and mixtures thereof. Tapioca starch can be substituted for tapioca flour. All of these methods are equally applicable to rice and to rice/tapioca blends. Fully cooked gelatinized rice or tapioca starch can be from about 75% to about 100% gelatinized. Partially cooked rice flour and the extruded rice flour can be from about 25% to about 100% gelatinized, and parboiled rice flour can be from about 75% to about 100% gelatinized.

Extrusion can be one method of gelatinizing the tapioca or rice flour for some embodiments of this invention. Extrusion provides the cooking conditions required for the starch of the rice or tapioca flour to completely cook, resulting in complete gelatinization and high levels of dextrinization of the starch—i.e., starch degradation. The use of extrusion to prepare the rice flours can result in the absence of a raw starch taste or the powdery starchy aftertaste and the uncontrolled and excessive expansion in the finished product. As is discussed below, extrusion is not desired for use in drying the dough or cooking the snack chip. Extrusion, while being one method for preparing the starch alone, is believed to degrade both the flavor and the nutritional value of the non-starch ingredients, in this case the added fruit ingredient, including a fruit puree. In one embodiment, drying the dough to make a half product and/or to make a snack chip is achieved via non-extrusion techniques, including drying at relatively low temperatures and/or at atmospheric pressure.

Optionally, an emulsifier can be added to the starch material as a processing aide to complex the free amylose generated during cooking and/or milling. In non-limiting examples, mono- or di-glycerides can be added at a level ranging from about 0.2 to about 0.7%, or from about 0.3% to about 0.5% (on a dry solids basis). Adding emulsifiers is well known in the art of snack products, and any other emulsifier consistent therewith can be added.

The starch materials can be ground to a wide range of particle size distribution. In one embodiment, the composition has a particle size distribution such that about 35% of the starch materials remain on a US #100 mesh. In another embodiment, the starch materials have a particle size distribution wherein from about 5% to about 30% remains on a 60 mesh screen, from about 15% to about 50% remains on a 100 mesh screen, and from about 20% to about 60% remains on a 200 mesh screen. Particle size distribution of the starch materials can help ensure proper hydration during mixing. Also, the particle size distribution can have an effect on texture; large particles in the starch materials can contribute to slow melting and tooth packing.

Fruit purees and puree concentrates can be made by means known in the art, such as the methods used to make applesauce.

E. FABRICATED SNACK PRODUCT PREPARATION

In one embodiment, a fabricated snack product can be a “half-product.” A “half-product” as used herein refers to a product that is dried to a moisture level that renders it shelf stable and ready for additional drying, baking, and/or cooking. While a fabricated snack product can be consumed at this point, it generally is not in a consumer desirable form. More specifically, the taste and texture of a half-baked product generally is not acceptable to a consumer.

In another embodiment, a fabricated snack product can be dried to a moisture level of between 1% and 3% such that it is ready to eat in a consumer desirable form.

In one embodiment, a fabricated snack product can be made by combining dry ingredients with water to form a dough, which is then sheeted, cut into pieces of a desirable shape, and dried. In one embodiment the drying can be done without extrusion, and at a temperature of less than about 300 F to form a half product. In this embodiment, the dough can have a moisture level of between about 4% to 12%. To form a consumer desirable snack chip, the half-baked fabricated snack product can be further dried or cooked by any of the methods discussed herein. In one embodiment drying is achieved at atmospheric pressure and without the use of extrusion.

In one embodiment, a fabricated snack product can be made by combining a puree, a dehydrated fruit, or vegetable powder with starch ingredients to form a dough, which is then sheeted, cut into desirable shaped pieces, and dried. In one embodiment, the fruit puree can be an apple puree. In one embodiment, the starch can be combined with the puree in the absence of any leavening system. In one embodiment, the starch can be a pre-gelled, partially cooked Kraft™ tapioca. In one embodiment, the starch can be a combination of pre-gelled Kraft™ tapioca or fully cooked Tistar™ tapioca and optionally rice or wheat flour at levels to provide for sheetability. In one embodiment, the drying can be done without extrusion and at a temperature of less than about 300 F to form a half product, i.e., until the dough has a moisture level of between about 4% to 12%. To form a consumer desirable snack chip, the half-baked fabricated snack product can be further dried or cooked by any of the methods discussed herein. In one embodiment, drying can be achieved at atmospheric pressure and without the use of extrusion.

In one embodiment, a fabricated variegated snack product can be made by using a split-dough system whereupon a first dough is prepared by combining a first puree, in particular a fruit puree, with starch ingredients to form a first dough. A second dough is prepared with starch ingredients and optionally adding a second puree, in particular a fruit puree that can have a different color. A final dough of the desired composition is prepared by commingling said first dough with said second dough, which is then sheeted, cut into desirable shaped pieces, and dried. Picture No. 1 shows apple-cherry variegated chips. Not only are variegated chips more visually appealing to consumers, but concentrating the fruit or different fruits, for example, in localized areas within a chip allow those fruits to better display their characteristic tastes, as opposed to a diluted and more muddled taste-effect that could be created if the dough were homogeneously mixed. In some embodiments, the split-dough system is not limited to two doughs, since any number can be prepared depending on the intended final effect. The doughs prepared for commingling can be based on ingredient composition and processing conditions that produce smaller drier crumbs or dough-balls having a less cohesive nature. This condition allows for better aggregation of the separate doughs to form the final dough. One skilled in the art will realize that if the individual doughs were too dry or dissimilar in their physical properties, the separate doughs may segregate, producing a sub-standard effect. If a more cohesive final dough is needed to prevent exaggerated segregation of the doughs or to improve the sheeting operation, the commingled dough can be mixed longer to produce a more cohesive dough. Alternatively, an optional ingredient can be added to aid in creating a more cohesive dough, such as the addition of a small amount of water. In one embodiment, oil is added to at least one of the said doughs. Not wishing to be bound by theory, but it is believed that the addition of oil produces a hydrophobic boundary on the surface of said first dough which retards further intermixing of said first dough with said second dough. Too much intermixing or blending of said first and second dough can produce a more homogeneous dough especially after sheeting, negating or reducing the intended variegated effect. Depending on the ratio of said first dough to said second dough, or any other additional dough, as well as the extent of the variegation pattern desired, one skilled in the art can empirically determine the size of the crumb or dough-balls of each dough, as well as manipulation of the cohesive properties of said doughs via formulation and/or processing to prepare the final dough. A small crumb size of said first dough within a continuous second dough generally can produce a spotted variegated effect when sheeted. Increasing the crumb size of the said first dough can produce a long streaking effect. Additional effects can be created or controlled via lamination of sheeted dough layers. Laminations can in effect be the same dough layered upon itself in the same direction from which it came or transposed in a cross-direction. Alternatively, the variegated sheet can be laminated with another separate dough, whereupon the variegation can be effectively evident on only one plane of the sheet and subsequent chip that is produced. Alternatively, the variegated sheet can be laminated with another dissimilar and separate variegated dough, whereupon the first variegation is effectively evident on only one plane of the sheet and subsequent chip that is produced, and where the second variegation is effectively evident on the opposite plane of the sheet and subsequent chip that is produced.

In yet another embodiment, it was surprisingly discovered that the intensity and thus the vibrancy of various fruits and vegetables used can be naturally accentuated by the addition of a combination of lemon or lime juice concentrate and acerola, or West Indian cherry juice concentrate, and subjecting the dough to sheeting and drying. The accentuation can be especially evident with variegated colors of split dough products. It has been known and practiced in the industry to add preservatives, for example sulfur dioxide, bisulfite materials, or organic acids, such as ascorbic acid or citric acid, in order to help maintain initial product color and/or extend the shelf life of vegetable or fruit puree materials. Here the role of these additives can be to prevent the enzymatic browning reactions that occur when fresh fruits and/or vegetables are chopped, as in the initial step of puree processing. It has been surprisingly discovered that the addition of both citric acid and ascorbic acid, or botanical sources containing high levels of citric acid and ascorbic acid added to some fruit and vegetables immediately prior to processing into a dough can increase or accentuate the fruits' or vegetables' natural color beyond maintaining it, resulting in the snack chip becoming more vibrant and pronounced when subsequently dried. Picture No. 1 shows apple-cherry variegated chips. Picture No. 2 shows apple-cherry variegated chips, where lemon juice and acerola were added to the cherry puree comprising the first dough. Here, the chemical compounds classified as anthocyanins, which are responsible for the color of the juice in the variegate, complex first with residual metal ions such as iron that are commonly found in most fruits and vegetables and then further complex with the ascorbic acid that is delivered by the acerola juice concentrate in a moderately acidic environment provided by the lemon or lime juice concentrate intensifying and stabilizing the color of the inherent anthocyanins. Although higher usage amounts of acerola can accomplish the intensifying effect by itself due to its inherent acidic nature, the addition of lime or lemon can be more effective in lowering pH and can be more cost effective. Alternatively, citric and ascorbic acid can be added to promote the intensifying effect. However, these compounds may not be as label-friendly to concerned consumers, as are lemon and West Indian Cherry, for example. In some fruits, such as banana, the precursors to the anthocyanins are found in high concentration and in an acidic environment they hydrolyze to produce anthocyanins that complex in the same manner as above giving pink to reddish colors. Thus, not wishing to be limited by theory, various colored fruits such as aronia, blackberry, blackcurrant, chokeberry, fig, sweet cherry, sour cherry, crowberry, elderberry, goji berry, red grape, huckleberry, litchi, mangosteen, pomegranate, miracle fruit, pear, plum, red raspberry, black raspberry, red currant, strawberry, tamarillo fruit, bilberry, blueberry and cranberry can be used to provide the variegate colors due to the presence of anthocyanins in their juices and purees.

Other fruits, such as banana, boysenberry, date, gooseberry, white grape, kiwi, logan berry, mango, pear, persimmon, and sapodilla, that contain anthocyanin precursors such as proanthocyanins, can be used also as sources of anthocyanins in combination with the lemon or lime juice to generate anthocyanins during the drying operation. These in situ generated anthocyanins can react in the same manner as the inherent anthocyanins and give intense colors to the variegates.

In yet another embodiment, vegetables containing chemical compounds classified as anthocyanins or that contain anthocyanin precursors such as proanthocyanins can also be used as sources of anthocyanins in combination with the lemon or lime juice to generate anthocyanins during the drying operation. These in situ generated anthocyanins will react in the same manner as the inherent anthocyanins and give enhanced color to the vegetables, especially in a variegated chip.

In yet another embodiment, variegated vegetable chips can be made using the natural colors found in other vegetables, such as beet, egg plant, colored corn purees, and curcuma longa root powders and purees, by mixing of the vegetables.

In yet another embodiment, tea, coffee, and cocoa extracts can also be used to provide the color component of the variegated chips. In yet another embodiment, dairy products such as whey solids, non fat dry milk solids, and casein isolates can also be used to prepare chips in combination with the tea, coffee, and cocoa extracts. Tea, coffee and cocoa extracts are by themselves intensely colored and heat stable and may need no enhancement in order to provide colors to the variegates.

Snacks according to embodiments of the present invention can provide substantial nutrition in a consumer acceptable format. That is, they can be both tasty and nutritious. The present combination of composition and processing results in a snack that retains more nutritional elements, more flavor components, and produces fewer off-flavors. By way of example, a snack chip made with fresh or dehydrated apples can retain more of the essential nutrients of the original apple material than prior snacks or currently offered snacks. Likewise, important and desirable flavor notes of the apple are retained in greater quantities by the compositions and processes of embodiments of the present invention.

Although the use of the dehydrated fruit materials in combination with the starch materials will be described primarily in terms of a fabricated snack product, it should be readily apparent to one skilled in the art that the dough formed with these compositions can be used in the production of any suitable food products. For instance, the dough can be used to produce food products such as crackers, fried snacks, fruit and vegetable snacks, baked or dried snacks, coatings for fried foods, baby foods, dog foods, dog biscuits and any other suitable food product. The production of one embodiment of a fabricated snack product is set forth in detail below.

### 1. DOUGH FORMULATION FROM DRY BLEND

Doughs of embodiments of the present invention can comprise a dry blend and added water. In one embodiment, the doughs comprise from about 55% to about 85% dry blend and from about 15% to about 45% added water. Water can be added to a level of about 15% and 35%, or between about 15% and about 30%, by weight of the dough. The dough can further comprise optional ingredients, including those that decrease the moisture content of the dough. For example, to lower the moisture content in the dough, the following ingredients can be added: 1) hydrolyzed starches into the dough, such as maltodextrins with low dextrose equivalent values; 2) polysaccharides such as xanthans, hydroxypropyl cellulose, and combinations and mixtures thereof; and 3) emulsifiers.

### a. DRY BLEND

Doughs can comprise from about 55% to about 85% dry blend, or from about 65% to about 75% dry blend. The dry blend can have a particle size distribution wherein from about 5% to about 30% remains on a 60 mesh screen, from about 15% to about 50% remains on a 100 mesh screen, or from about 20% to about 60% remains on a 200 mesh screen.

The dry blend can comprise fruit source solids, starch materials, and optional dry ingredients. Dry blends can comprise from about 7% to about 50%, by weight of the dry ingredients, fruit source solids; from about 12% to about 50%, by weight of the dry ingredients, starch material; and from 0% to about 81%, by weight of the dry ingredients, optional ingredients. Furthermore, the balance of the dry blend can comprise one or more other components including but not limited to, protein sources, fiber, minerals, vitamins, colorants, flavors, fruits pieces, vegetables, seeds, herbs, spices, salt, oil, sugar, sweeteners, and combinations and mixtures thereof. It is sometimes beneficial to coat these other components before they are added to the dry blend. Coatings can be applied to protect the components so that negative catalytic effects are avoided.

### b. ADDED WATER

Dough compositions of embodiments of the present invention can comprise from about 0% to about 40% added water, or from about 15% to about 35%, or from about 15% to about 30% added water. It should be understand that added water can also be considered an optional ingredient. If optional ingredients, such as maltodextrin or corn syrup solids, juices, concentrates, are added as a solution, the water in the solution is included as added water. The amount of added water also includes any water used to dissolve or disperse ingredients.

### c. OPTIONAL INGREDIENTS

Any suitable optional ingredient may be added to the doughs. Such optional ingredients can include, but are not limited to polysaccharides such as: gums and fibers, emulsifiers, oils, water, and combinations and mixtures thereof. Optional ingredients can be included at a level ranging from about 0% to about 81%, or 0% to about 40%, by weight in the dough. Examples of suitable gums can be found in U.S. Pat. No. 6,558,730, issued May 6, 2003, to Gizaw et al. Optional ingredients include, but are not limited to, vegetables (e.g. tomatoes, carrots, peppers, and the like) and legume sources (e.g. pinto beans, garbanzo beans, green peas, and the like).

An optional ingredient can be oatmeal, which may be present at from 0% to about 25%, or from about 5% to about 20% of the snack chip. Other optional ingredients are selected from the group consisting of salt, sugar, cinnamon, butter, spices, artificial flavors, artificial sweeteners, oil, fruit pieces, peel, zest, seeds, and combinations and mixtures thereof.

Additional starch materials may be added also, for example, oat, wheat, rye, barley, corn, masa, cassava, non-masa corn, dehydrated potato products (e.g., dehydrated potato flakes, potato granules, potato flanules, mashed potato materials, and dried potato products), sago as well as legumes, such as beans, peas, lentils, chickpeas, and combinations and mixtures thereof. These other starch materials can be blended to make snacks of different compositions, textures, and flavors.

An ingredient that can optionally be added to the dough to aid in its processability is one or more emulsifiers. The addition of an emulsifier to the dough reduces the stickiness of the dough which minimizes sticking to the sheeting rolls, belts, and the like. Emulsifiers also have an effect on the texture of the final product, wherein higher levels of emulsifier result in denser finished products. An emulsifier can be added to the dough composition prior to sheeting the dough. The emulsifier can be dissolved in a fat or in a polyol fatty acid polyester such as Olean™. Suitable emulsifiers include lecithin, mono- and diglycerides, diacetyl tartaric acid esters and propylene glycol mono- and diesters and polyglcerol esters and sucrose polyesters. Polyglycerol emulsifiers such as monoesters of hexaglycerols can be used. Non-limiting examples of monoglycerides include those sold under the trade names of Dimodan available form Danisco®, New Century, Kans. and DMG 70, available from Archer Daniels Midlands Company, Decatur, Ill.

When calculating the level of optional ingredients, that level of optional ingredient that may be inherent in the dehydrated fruit materials and starch material is not included.

It also should be understood that as the amount of fruit or vegetable source solids is changed, which can frequently occur when determining which specific fruit or vegetable will be used and when determining how many servings of the fruit or vegetable will be provided, the amount of starch materials and optional ingredients will change as well. For example, when comparing an apple and a banana, more fruit source solids of banana are required to provide a full serving of banana than when providing a full serving of an apple. Thus, less starch materials and optional ingredients are needed for a banana snack than with an apple chip. Again, these amounts can be dependent on the number of servings being provided and on the particular fruit or vegetable source solids selected.

### 2. DOUGH FORMULATION FROM PUREE

In one embodiment, doughs can be prepared in the absence of leavening systems, maltodextrins, and hydrolyzed starches. In one embodiment, doughs can comprise a puree of at least one fruit combined with starch components, which can be pre-gelled starch components. Purees can be depectinized in concentrate form and can optionally be combined with other ingredients, such as oats or oatmeal. Combining with ingredients such as oats or oatmeal can effectively aid in sheeting by minimizing undesirable stickiness of the dough, and increasing the dough strength. In another embodiment, a mixture of puree and dry fruit powders can also be used.

### 3. DOUGH PREPARATION

The doughs can be prepared by any suitable method for forming sheetable doughs. In a dry blend composition, a loose, dry dough can be prepared by thoroughly mixing together the ingredients using conventional mixers. A pre-blend of the wet ingredients and a pre-blend of the dry ingredients can be prepared; the wet pre-blend and the dry pre-blend can then be mixed together to form the dough. Hobart® mixers can be used for batch operations while Turbulizer® mixers can be used for continuous mixing operations. Alternatively, low pressure forming extruders can be used to mix the dough and to form sheets or shaped pieces.

In a dough formulation from puree, the puree can optionally be mixed with added water or other liquid to a desired consistency and then be added to pre-gelled or a combination of pre-gelled and fully cooked starch to form a sheetable dough product. Hobart® mixers can be used for batch operations while Turbulizer® mixers can be used for continuous mixing operations.

### a. SHEETING

Once prepared, the dough can be formed into a relatively flat, thin sheet. Any method suitable for forming such sheets from starch-based doughs can be used, but methods that put relatively low work into the dough are believed to be better for ultimate flavor retention in the final snack chip. For example, the sheet can be rolled out between two counter rotating cylindrical rollers to obtain a uniform, relatively thin sheet of dough material. Any conventional sheeting, milling, and gauging equipment can be used. The mill rolls can be cooled to from about 5° C. to about 20° C. In one embodiment, the mill rolls can be kept at two different temperatures. The dough can also be formed into a sheet by a form extrusion device that does not cook the dough.

Doughs can be formed into a sheet having a thickness ranging from about 0.015 to about 0.10 inches (from about 0.038 to about 0.254 cm), or a thickness ranging from about 0.019 to about 0.05 inches (from about 0.048 to about 0.127 cm), or about 0.02 inches to about 0.03 inches (0.051 to 0.076 cm).

Dough sheets can have a sheet strength of from about 80 gf to about 400 gf, or from about 85 gf to about 300 gf, or from about 95 gf to about 150 gf.

In embodiments comprising fruit source solids, the dough can be relatively strong even when sheeted to a relatively low thickness and contains relatively high levels of fruit source solids. The sheet strength increases as the level of fruit source solids decreases. The rice and tapioca based starches can enable the incorporation of fruit source solids into the formulation of snacks due to their ability to increase sheet strength. The present rice and tapioca flour composition can be an excellent carrier for food pieces in the dough, for example, pieces of fruit, vegetables, whole grains, nuts and the like.

The dough sheet can then be formed into snack pieces of a predetermined size and shape. The snack pieces can be formed using any suitable stamping or cutting equipment. The snack pieces can be formed into a variety of shapes. For example, the snack pieces can be in the shape of ovals, squares, circles, a bowtie, a star wheel, or a pin wheel. The pieces can be scored to make rippled chips as described by Dawes et al. in PCT Application No. PCT/US95/07610, published Jan. 25, 1996 as WO 96/01572, or docked, where holes are punched into or through the dough.

### b. FINISHING OF THE DOUGH PIECES INTO CRISPS

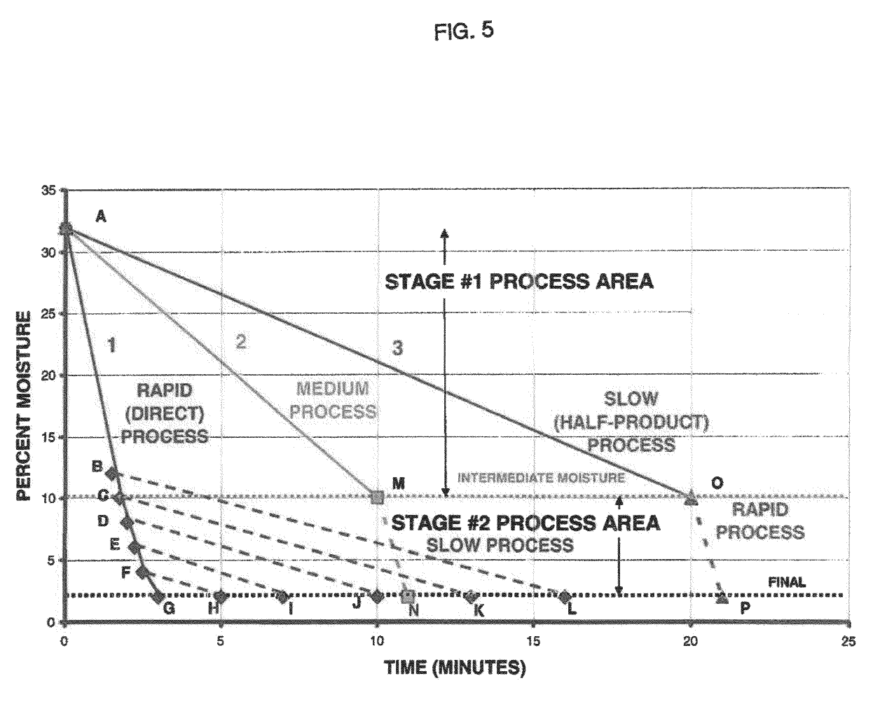

Finishing of the snack pieces to make products can be done by a two stage baking/drying process. FIG. 5 provides a graphical representation of how these two stages may be achieved. Curves 1, 2, and 3 represent fast, medium, and slow finishing process Stage 1 conditions, respectively. In some cases, the products may be finished in a single stage baking process, shown as curve 1 and following a path from points A to G. In other cases, a two stage process can be used. The two stages can be represented by any curve that could be shown in FIG. 5. A typical process begins with a Stage 1 condition at around 32 percent moisture and follows to a 10 percent moisture point. Any combination of time and temperature to reach this point can be used, non-limiting examples of which are recited hereinafter. A Stage 2 process can then be used to reach an approximate moisture content of about 2% to about 3%. Again, any combination of time and temperature to reach this point can be used, non-limiting examples of which are recited hereinafter.

The choice of Stage 1 and Stage 2 process conditions can be dependent on: 1) the properties of the snack pieces, 2) the desired properties of the finished product, and 3) the economics of the operation.

Examples of initial snack piece properties include thickness and shape. Thick snack pieces, for example greater than about 0.050″, may require a slow Stage 1 process, followed by a rapid Stage 2 process. Thinner snack pieces may be able to be processed by rapid high temperature Stage 1 process, followed by a slower low temperature Stage 2 process without creation of finished product negatives.

Examples of desired product properties can be textural hardness, crispness, expansion, and water absorption. If intermediate moisture levels are too high or too low, finished product expansion can be inhibited, which can create undesirable textural properties. Another example of desired product properties can be the color or degree of browning.

Yet another example of desired product properties can be the retention of flavor and nutrients. In some cases, it is desired to maintain the rate of moisture removal such that the water diffusion rate inside the product keeps up with the removal rate by the process. It is believed, not to be bound by theory, that when the moisture removal rate is equal to or less than the moisture diffusion rate, the outer surface remains moist and does not rise significantly above 212 F. This condition helps maintain the flavors and nutrients. When the moisture removal rate becomes greater than the moisture diffusion rate inside the product, the outer surface dries out and can rise well above 212 F. This condition can be detrimental to flavors and nutrients and can promote their degradation and loss of volatiles. This condition may also create undesirable textural effects. The snack piece's intermediate product thickness and/or geometry can have an effect on the diffusion rate of moisture, even sometimes requiring the process to be reduced in temperature and time to maintain the desired balance between moisture diffusion rate and moisture removal rate.

Economic considerations may indicate a rapid Stage 1 process or a hold time between the two stages at an intermediate product moisture.

In FIG. 5, Point A represents the initial moisture of the dough of one embodiment. A typical moisture value of 32% is shown, but dough moistures can range from about 20% to 45%. It is also known that the dough sheet can loose up to several percent moisture between the sheeting operation and the start of the baking/drying operation.

The finished product moisture may vary between about 0% and 4% and may typically between 2% to 3% for crispy products. The finished product moisture is normally chosen to provide the desired texture. Moistures higher than about 3% tend to produce a less crispy and more chewy texture. Moistures below about 2% tend to produce a glassy crispness and may be difficult to achieve by the processing conditions. Process time and damage to the product can become concerns. If chewy textured products are desired, final moisture can be as high as about 10%, providing the water activity is low enough to provide for microbial stability.

The intermediate moisture line, shown in FIG. 5 as a dotted line at 10 percent moisture, can represent a typical transition between Stage 1 and Stage 2 processes, but the transition can vary from about 16% to the finished product moisture. If the product is to be held at the intermediate moisture for longer than a few hours, microbial issues can occur if the moisture, and corresponding water activity is too high. The intermediate product's water activity can be chosen to provide microbial stability for the holding storage time and conditions. Water activity is determined by product moisture content and composition and is generally between about 0.60 and about 0.80 for microbial stability. In one embodiment, a half product can have a water activity of less than about 0.65. A typical microbial stable moisture value for products can be about 10%. If the product enters Stage 2 in a short time after exiting Stage 1, then microbial issues are of much less concern, and the intermediate moisture content can be as high as about 16%.

Water activity is determined by the product's moisture content and composition and can be less than 0.6 for long term stability.

A rapid Stage 1 process can be represented by curve 1. During this process condition, moisture is removed quickly, and chemical reactions can occur in the dough. The majority of the snack product's structure can be formed in the rapid Stage 1 process. Convective, conductive, radiant, microwave, radio frequency, or some combination can be used to achieve the moisture-time profile of curve 1. Also, multi zones within the same baking or drying system can be used. For example, a two zone baking oven might have a zone 1 temperature of 500 F, and a zone 2 temperature of 400 F, and may have a total bake time of about 2 minutes to achieve an intermediate moisture level of about 4% to 8%. Also, the temperature and method of heat application to the product can be different for the top and bottom. The time to get the product to the intermediate moisture can also be dependent on the baking temperature, time, and method of application, as well as product thickness, geometry and composition. The openness of the oven belt can influence the drying characteristics as well. More open belts can allow for quicker drying while closed belts allow for slower drying.

Stage 2 processing conditions typically can follow a rapid Stage 1 process, such as curve 1, and can be represented by the dashed lines. The inflection point in the curve can represent where the product was transitioned or transferred to the Stage 2 drying conditions. For example, a product starting at point A and having a 32% moisture content can be rapidly dried following curve 1 until it reaches point D in approximately 2.0 minutes at an approximately 8% moisture content. The product can then be transferred to a Stage 2 dryer whereupon its processing conditions allow the product to dry along the path shown by dashed line D-J over a duration of approximately 8 minutes and reaching a final moisture level of about 2%. Total cumulative drying time from both stages thus can be 10 minutes. Stage 2 drying conditions can be determined so as to remove the remaining moisture from the product to achieve the final product moisture without creating finished product negatives such as burning, texture issues, or degradation of flavors or nutrients. In the case of a rapid process, such as curve 1, a slower low temperature Stage 2 drying conditions can often be required to achieve the final product moisture. For example, if a product composition is susceptible to excessive browning, a high temperature rapid Stage 2 drying, such as that drawn from point C to point H, may cause objectionable browning or burning of the product as compared to one dried following a Stage 2 process following a curve represented by point C to point K. Also, loss of flavor volatiles, nutrients, and textural negatives can occur. A lower process temperature and longer time may be required to remove the last amount of water and achieve the final product moisture. Examples of these slower process curves can be represented in FIG. 5 as curves from points B to L, C to K, D to J, E to I, and F to H. One method of drying can be represented in FIG. 5 as a rapid Stage 1 process going from approximately point A to point C, followed by a slower Stage 2 process going from points C to K. The drying rate for a product processed to a given intermediate moisture may be adjusted to optimize the properties of the product at its final moisture. Very little additional structure is usually developed in Stage 2 with the slow process conditions. Products undergoing a slow process condition in Stage 2 may be spaced closely together, overlap, or even form a bed of individual products provided the desired moisture removal process is not impeded.

A slow Stage 1 process shown by curve 3 can be indicative of a low temperature drying operation. The process conditions are determined to remove about 50% or more of the initial moisture from the snack pieces to achieve the desired intermediate product moisture without creating negatives such as burning, texture issues, or degradation of flavors or nutrients. During this condition, moisture is removed more slowly than for the rapid process, and lower temperatures and longer times can be used. Some chemical reactions can occur in the dough, but they are of a much lesser degree than for a rapid process. Humidity may be controlled in this process to facilitate moisture removal without damage to the product. An example of a slow Stage 1 process would be a temperature of 200 F to 250 F, for 15 to 30 minutes. Any of the methods of heating listed above for the rapid process can be acceptable. Half-products often use this type of process. Products undergoing a slow process condition in Stage 1 may be spaced closely together, overlap, or even form a bed of individual products provided the desired moisture removal process is not impeded.

A Stage 1 drying process can be a slow, relatively gentle process that tends to not degrade the authentic flavor and nutritional value of the non-starch ingredients, including the fruit ingredients. Any of a number of methods can be used, including those hereinabove and hereinafter, for example, baking, vacuum drying, microwave heating, and combinations and mixtures. In one embodiment, the drying step can be chosen and regulated in temperature and time such that little or no gelatinization of the starch occurs during this step. In this embodiment, at least a portion of the starch materials can be gelatinized before forming and drying the dough. Moreover, in such embodiments, gelatinization of the starch will not occur during drying because the moisture content of the dough is too low. As discussed above, in some embodiments a relatively high moisture content is a necessary part of the gelatinization process. In other embodiments, the moisture content can be kept relatively low to form a good sheeted product and to minimize the time and energy necessary for drying.

In one embodiment, processing to a half product can be achieved by drying at sufficient heat to drive the moisture content of the sheeted dough from above 30% to about 10% in less than 5 minutes. In another embodiment, processing to a half product can be achieved by drying at sufficient heat to drive the moisture content of the sheeted dough from above 30% to about 10% in 10 to 15 minutes. In another embodiment, processing to a half product can be achieved by drying at sufficient heat to drive the moisture content of the sheeted dough from above 30% to about 10% in from 20 to 25 minutes. It is well known in the art that the movement of heated air such as that used in forced convection ovens will help facilitate the drying process.

Additional processing of the half product can be accomplished at relatively low temperatures and at atmospheric pressures by conventional means. In one embodiment, drying to a final moisture content from a half product can be achieved by drying at sufficient heat to drive the moisture content of half product to about 1% to 3% in less than 10 minutes. In one embodiment, drying to a final moisture content from a half product can be achieved by drying at sufficient heat to drive the moisture content of half product to about 1% to 3% in less than 3 minutes.

The snack pieces can optionally be cut from the sheeted dough described above before drying to a half product, or the dough can be dried to make the half-product and then snack pieces cut to shape and size for further drying or cooking.

Stage 2 processing conditions following a slow Stage 1 process, such as curve 3, can be determined to develop the finished product structure. This process condition may need to be a fast high temperature process, such as dashed curve from point O to point P in FIG. 5. For example, products that are processed in Stage 1 at 250 F for 20 minutes to an intermediate moisture of about 10% can require a Stage 2 processing condition of 300 F to 400 F for about 1 to 2 minutes to obtain final moisture and develop the desired finished product structure. Care must be taken to select Stage 2 processing conditions that do not create finished product negatives such as burning, texture issues, or degradation of flavors or nutrients.

The medium Stage 1 process curve 2 represents process conditions between the rapid curve 1 and the slow process curve 3. This type of Stage 1 processing condition can require the appropriate Stage 2 process conditions, for example dashed curve M-N, to achieve the desired final product texture and moisture without creating finished product negatives such as burning, texture issues, or degradation of flavors or nutrients.

### c. ALTERNATE FINISHING OF DOUGH INTO CRISPS

The half product described above can be further dried or cooked to make a crisp snack product. Further drying or cooking can be accomplished at some time after making the half product, or essentially directly after, such that the half product stage is transient, and drying occurs from the sheeted dough to the snack product having from 1% to 3% moisture in one continuous process.

After the half-baked fabricated snack products are formed, they can be cooked to form a crisp snack chip. The fabricated snack products can be fried, for example, in a fat composition comprising digestible fat, non-digestible fat, or combinations and mixtures thereof. For best results, clean frying oil should be used. The free fatty acid content of the oil can be maintained at less than about 1%, or less than about 0.3%, in order to reduce the oil oxidation rate. Any other method of cooking, such as baking, vacuum drying, microwave heating, and combinations and mixtures of these, is also acceptable. When the snack chips are cooked by a method other than frying in oil, it is often desirable to add some oil to the dough as an optional ingredient as described above. Oil can be added to snack chips that are fried as well.

In one embodiment, the frying oil can have less than about 30% saturated fat, or about 25%, or less than about 20%. This type of oil improves the lubricity of the finished snack chips such that the finished snack chips have an enhanced flavor display. The flavor profile of these oils also can enhance the flavor profile of topically seasoned products because of the oils' lower melting point. Examples of such oils include sunflower oil containing medium to high levels of oleic acid.

In another embodiment, the fabricated snack products are fried in a blend of non-digestible fat and digestible fat. The blend can comprise from about 20% to about 90% non-digestible fat and from about 10% to about 80% digestible fat, or from about 50% to about 90% non-digestible fat and from about 10% to about 50% digestible fat, or from about 70% to about 85% non-digestible fat and from about 15% to about 30% digestible fat. Other ingredients known in the art can also be added to the edible fats and oils, including antioxidants such as TBHQ, tocopherols, ascorbic acid, chelating agents such as citric acid, and anti-foaming agents such as dimethylpolysiloxane.

In another embodiment, the fabricated snack products are fried in oils with low levels of saturated fat, such as high oleic sunflower oil, corn oil, rice oil, mid oleic sunflower oil, palm oil, and combinations and mixtures thereof.

Frying of the fabricated snack products can occur at temperatures of from about 275° F. (135° C.) to about 420° F. (215° C.), or from about 300° F. (149° C.) to about 410° F. (210° C.), or from about 350° F. (177° C.) to about 400° F. (204° C.) for a time sufficient to form a product having about 6% or less moisture, or from about 0.5% to about 4%, or from about 1% to about 3% moisture.

In some embodiments, the fabricated snack products can be fried in oil using a continuous frying method and are constrained during frying. This constrained frying method and apparatus is described in U.S. Pat. No. 3,626,466 issued Dec. 7, 1971 to Liepa. The shaped, constrained snack pieces are passed through the frying medium until they are fried to a crisp state with a final moisture content of from about 0.5% to about 4%, or from about 1% to about 2.5%.

Any other method of frying, such as continuous frying or batch frying of the fabricated snack products in a non-constrained mode, is also acceptable. For example, the snack pieces can be immersed in the frying fat on a moving belt or basket. Likewise, frying can occur in a semi-constrained process. For example, the fabricated snack products can be held between two belts while being fried in oil.

Oils with characteristic flavor or highly unsaturated oils can be sprayed, tumbled, or otherwise applied onto the fabricated snack products after frying. Triglyceride oils and non-digestible fats can be used as a carrier to flavors and can be added topically to the fabricated snack products. These include, but are not limited to, butter flavored oils, natural or artificial flavored oils, herb oils, and oils with potato, garlic, or onion flavors added. This method can be used to introduce oils which would ordinarily undergo polymerization or oxidation during the heating necessary to cook the snacks.

### F. PRODUCT CHARACTERISTICS AND ANALYTICAL METHODS

In one embodiment in which fruit puree was combined with starch components, including pre-gel starch components, good tasting, relatively low fat snack products can be produced. Low fat is a consumer desirable feature of snacks, and good taste is related not only to flavor but to texture and mouth melt. Mouth melt is an organoleptic eating parameter occurring in-mouth during mastication that can be characterized by the water absorption properties of a snack product. Products of embodiments of this invention produce a similar eating sensation to products containing much higher levels of fat. Not to be bound by theory, it is believed that the fat contained in high fat snacks coats the snack particulates that are formed during mastication, thereby inhibiting their saliva (water) absorption. Typical low fat products produce a dry sensation in the mouth because their particulates formed during mastication readily absorb saliva (water) from the in-mouth surfaces due to the reduced availability of fat. This low far product with a dry sensation can also result in increased chewing time and saliva generation required to form a bolus in-mouth before swallowing. Low fat containing snack products of embodiments of this invention can have water absorption properties similar to snacks containing much higher levels of fat. This chip can result in an organoleptic eating experience similar to that of the higher fat snacks.

In one embodiment, the snacks can have a percent fat of between about 0% and about 35% and any range therebetween %. In another embodiment, the snacks can have a water absorption of between about 1.5 and about 2.5. In one embodiment, fruit based snack products can have percent fat content less than about 12%. In one embodiment, fruit based snack products can have percent fat content less than about 12% and a Water Absorption value (grams/gram) of less than about 2.5. In another embodiment, snack products can have a percent fat content less than about 12% and a Water Absorption value (grams/gram) of less than about 1.75. In another embodiment, snack products can have a percent fat content less than about 10% to 12% and a Water Absorption value (grams/gram) of at least 1.5 and less than about 2.5. In another embodiment, snack products can have a percent fat content of greater than 3% and less than about 12% and a Water Absorption value (grams/gram) of at least 1.5 and less than about 2.5.

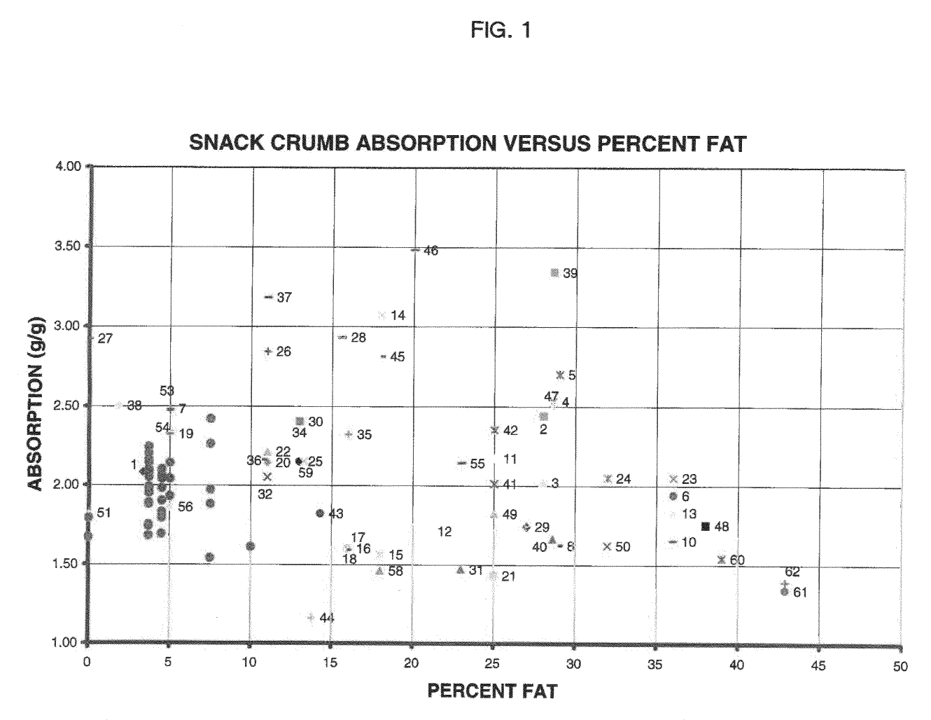

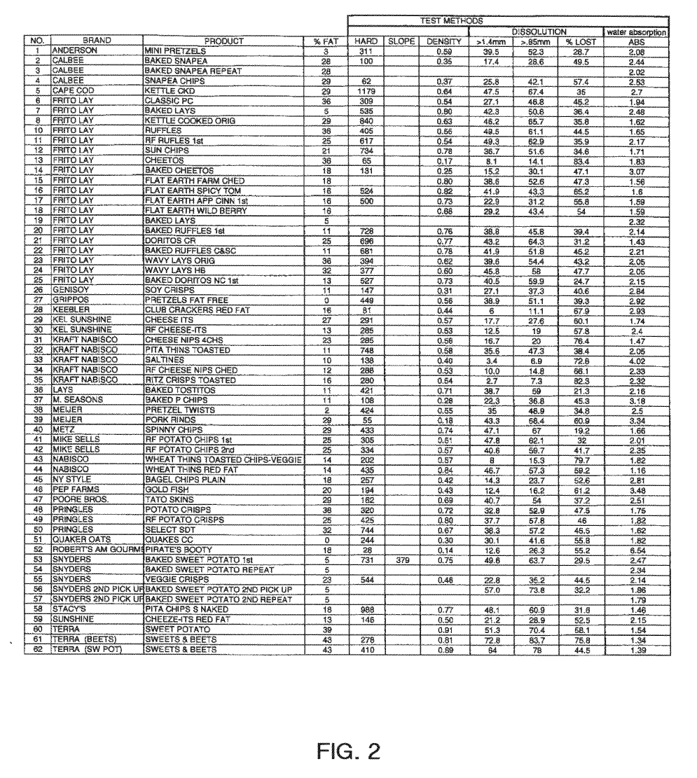

Embodiments of the present invention can be represented by the green colored circles plotted in FIG. 1, which is a graph of Snack Crumb Absorption versus Percent Fat. Snack crumb absorption can be determined by the Water Absorption Test described below. The commercial snack products shown on FIG. 1 were tested for various parameters as shown in the Table of FIG. 2. In FIG. 2, “ABS” stands for Water Absorption, which is the “Absorption” value of FIG. 1.

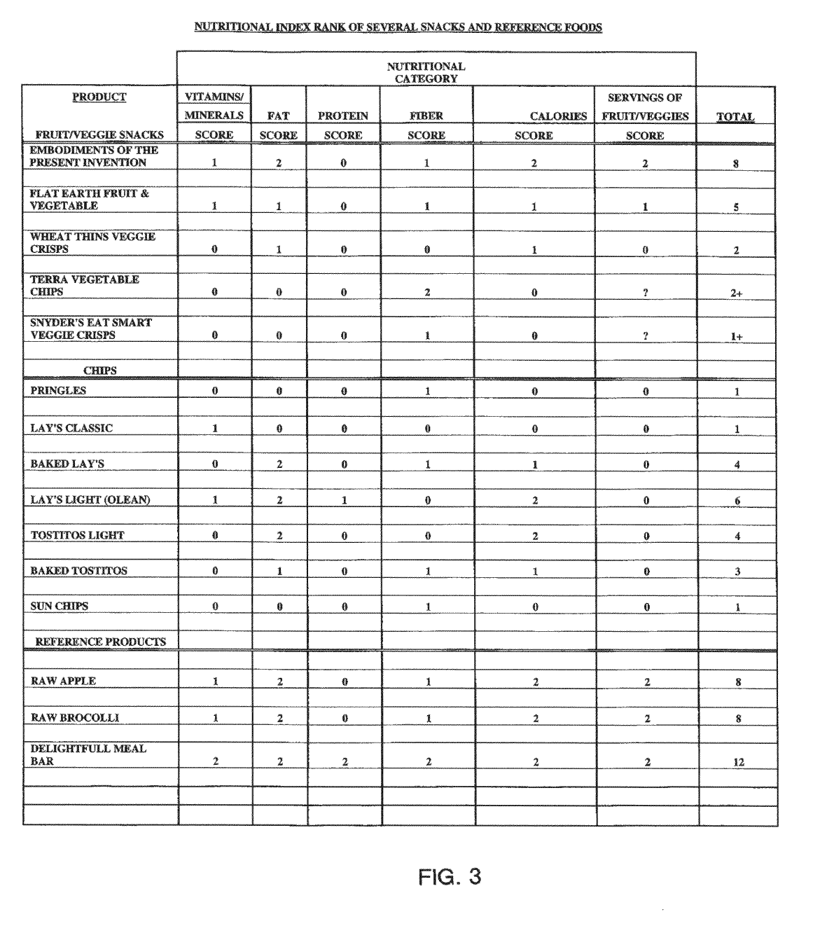

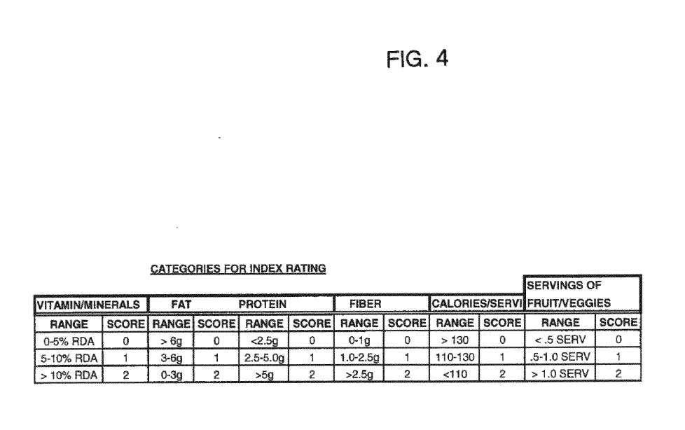

Embodiments of the present invention can also have a relatively high Nutritional Index, as calculated by the table of FIG. 3 based on the Index Rating as defined in FIG. 4. As shown in the table of FIG. 3, snack products of embodiments of the present invention can have a Nutritional Index of 8, which can be comparable to “Raw Apple” in nutrition value.

In some embodiments, the fabricated snack product can be cooked to form a snack chip that can have a chip fracture strength from about 100 to about 700 gram-force (gf), or from about 200 to about 600 gf, or from about 200 to about 400 gf. In other embodiments, the snack chips can have a fracture strength of from about 200 to about 300 gf, or from about 180 to about 280 gf. The chip fracture strength can at least partially vary depending on the type of fruit source solids or vegetable source solids used and can also at least partially vary depending on the processing used to produce the chip, including the two stage baking process used.

In some embodiments, the fabricated snack product can have a density of from about 0.3 to about 1.0 g/ml, or from about 0.4 to about 0.9 g/ml, or from about 0.4 to about 0.8 g/ml.

The flavor and texture of snack chips of embodiments of this invention can be as a result of making them from a dough sheet that is relatively thin, in some embodiments only 0.018 -0.055 inches (0.046 cm to 0.14 cm) thick, and formulated with low levels of moisture in the dough as described above. This low level of water and the presence of the starch materials in the formula allow the frying time to be substantially reduced to achieve the desirable texture. Since the fruit source solids can be in a dry form, the starch material can be partially pre-gelatinized, the frying energy required can be minimal, and lower fat absorption can take place during the abbreviated cooking process. Also, because of the low level of water used in the dough making process, the fat content of the chip will be lower than a typical fried snack.

The fruit based snack chip can have a range in total fat content from about 0 to about 35% and all ranges therebetween. The fat content of the finished snack chips can range from about 0 grams to about 9 grams per a 28 gram serving of chips. Snack chips made with nuts can be at the high end of this range. In some embodiments, the fat content of the snack chip can be less than about 9 grams of fat per a 28 grams serving of chips This content would represent an approximately 20% to 50% reduction in the fat content when compared to a chip processed under similar conditions but comprising potato flour, which is typically of 11 g per 28g serving. In embodiments wherein fruit source solids or vegetable source solids are utilized used, the fat content can be between about 0% to about 12% and all ranges therebetween. Of course, fat can be added that raises the fat content. This addition can be done by any method as is known in the art. The addition can raise the fat content so that it ranges between the 0 and 35% as mentioned above. Any addition can be done such that the fat content is at any range therebetween.

In one embodiment, the dough can be made into a fabricated snack product that is dried using microwave heating and then fried to a density from about 0.4 to about 1.0 g/ml.

1. CHIP DENSITY TEST PROCEDURE

The density of the snack product can be measured by means of Archimedes' principle (buoyancy method). Density is used in many areas to characterize certain properties of a product or material. The buoyancy method is a technique for measuring the bulk volume of a sample by submerging it in a bath of glycerin and observing the increase in weight of the bath, following Archimedes principle.

To conduct the measurement, fill a container with enough glycerin to submerge the sample being measured. Submerge a clip in glycerin so that the fine wire is at the interface, and tare the scale.

Carefully determine the weight of each sample with a balance. This weight determination should be made prior to the samples picking up a significant weight of water when exposed to the environment.

Attach the sample to clip and fully submerge in the glycerin, including clip. Make sure the sample does not touch the walls of the vessel. Record the weight. Repeat using 5 different samples times. Calculate density from the following equation:

$$Ds = \frac{Df \times Ws}{( Ws - F )}$$

Where:

Ds=Density of Specimen

Df=Density of Fluid (Glycerin=1.262)

Ws=Weight of Specimen Before Submerging

F=Reading on Scale with Specimen Submerged An average the 5 density readings is used.

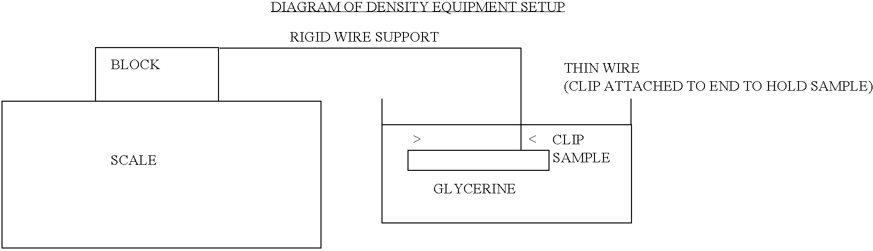

### 2. PERCENT FAT ANALYSIS

The percent of total fat in a chip can be measured by standard procedures known to those in the food arts. The total fat can be measured by acid hydrolysis. Specifically, the method for measuring total fat by acid hydrolysis can be found in AOAC International (2000) 17th edition AOAC International, Gaithersburg, Md., USA, Official Methods 922.06, 954.02, which is hereby incorporated by reference.

### 3. WATER ACTIVITY (Aw)

The water activity is defined as the ratio A_{w}=p/pₒ, where p represents the actual partial pressure of water vapor and pₒ the maximum possible water vapor pressure of pure water (saturation pressure) at the same temperature. The A_{w} level is therefore dimensionless; pure water has a level of 1.0, and a completely water-free substance has a level of 0.0. The relationship between the equilibrium relative humidity ERH in a food and the water activity is A_{w}X100=ERH.

Instrument:

Conductivity humidity meter Rotronic Hygroskop DT (model WA-40 TH) with an operational temperature range from 0 to 100C, and 0 to 100% RH.

Method:

1. Ensure that the temperature gauge on the DT unit displays 25±0.1° C. If not adjust water bath thermometer until the display shows 25±0.1° C.

2. Put sample in sample cup to cover base up to about 2 to 3 mm.

3. Put sample cup containing sample in the measuring cell and turn lever all the way to the right to isolate the measuring chamber.

4. Wait requisite amount of time until readings stabilize (Only the displays are lit up)-typically 45 min. to a few hours.

5. Record measurement and remove sample cup from measuring chamber.

6. In case of spillage, clean chamber with distilled water and air dry.

### 4. WATER ABSORPTION TEST

1. Fill a 250 ml beaker with 150 ml tap water at ambient temperature.

2. Select a tea bag with string, not of the flow thru design. Remove staple, empty and discard tea. The tea bag system will include the tea bag, staple, string, and the label tag attached to top of string.
a. Calculate the expected absorption for the tea bag system material by:
b. Weigh empty bag, with staple (same as those contained in the stapler), string and label tag.
c. Submerge in water for 60 seconds. All of the bag, and about ¼″ of the attached string should be submerged.
d. Remove from water and drain for 60 seconds.
e. Lightly shake off any excess water.
f. Weigh wet tea bag system.
g. Repeat 6 times to obtain the average water absorption (1-[wet weight/dry weight]) for the bag system.

3. Crush enough product to obtain about 2 g for test. Remove particles that do not pass through a No. 6 sieve (0.132″).

4. Select a dry bag, staple (same as those contained in the stapler), string & tag, and get a weight.

5. Place about 2 g of product in empty dry bag.

6. Fold down top of bag and staple closed. The string is attached to the bag by the same kind of staple.

7. Place tea bag containing product into the water such that it is fully submerged minimizing agitation for 60 seconds. All of the bag, and about ¼″ of the attached string should be submerged.

8. Remove the tea bag system containing product from water and drain with minimal agitation for 60 seconds. Shake lightly at end of 60 seconds to remove any droplets formed on the outside of the bag.

9. Weigh.

10. Calculate the water absorption of the product by:
Absorption Factor=[A−B×C−D]/D
   Where:
   A=Total Weight of Wet System
   B=Dry Bag System Weight
   C=1+Average % Absorption of Bag Material
D=Dry Sample Weight

### 5. CHIP FRACTURE FORCE

This method is based on Stable Micro Systems Texture Analyzer Model: Upgrade Plus Texture Technologies Corp., 18 Fairview Road, Scarsdale, N.Y. 10583-2136.

The instrument is setup with a 5 kg load cell. A three-pin tripod base (specification given below) is attached to the base of the Texture Analyzer (TA). The cylindrical probe (specifications given below) is attached to the force arm of the TA, and the instrument is calibrated for force following the instrument instructions. A test chip is positioned equidistantly on the tripod base. The instrument is run based on the TA settings conditions described below. The force arm descends bringing the cylindrical probe and chip into contact. Force is applied to the chip until a break is registered. The force arm then returns to its original position. A total of 20 chips are analyzed and the maximum peak force of each is determined. A Q-test analysis is applied to the data set to determine whether any data outliers exist at a 90% confidence level, and, if so, an observation can be removed from the analysis. Remaining observations are averaged and recorded as the sample's chip fracture force in gram force (gf).

T.A. Settings:

| Sequence Title | Return to Start | |
|---|---|---|
| Test Mode | 1 = Compression | Defines the initial probe direc- |
| | | tion and force polarity |
| Pre Test Speed | 0.33333 mm/sec | Speed while searching for the |
| | (20.0 mm/min) | trigger point |
| Test Speed | 0.08333 mm/sec | Speed of approach to target |
| | (5.0 mm/min) | (after triggering) |
| Post Test Speed | 0.83333 mm/sec | Speed at which the probe returns |
| | (50.0 mm/min) | to the start point |
| Target Mode | 0 = Distance | Select Distance, Strain, or Force |
| | | as the target parameter |
| Distance | 3.000 mm | Target distance/deformation |
| Trigger Type | Auto (Force) | Definition of the initiation of |
| | | data capture |
| Trigger Force | 5.0 g | Amount of force for the TA to |
| | | initiate data capture (normally |
| | | when product is detected) |
| Break Mode | Level | If and how the TA detects when |
| | | the product has broken |
| Break Sensitivity | 5.0 g | Sensitivity of the break detect |
| | | mechanism |
| Break Detect | Return | Action taken when a product |
| | | break is detected |
| Stop Plot At | Start Position | Determines at which point data |
| | | capture is switched off |
| Tare Mode | Auto | Determines when the force is |
| | | zeroed |
| Advanced Options | On | Determines if advanced options |
| | | are displayed |
| Control Oven | Disabled | |
| Frame Deflection | Off | |
| Correction | | |

Tripod Base and Cylindrical Probe Specifications

A Q-test Analysis can be applied to the dataset, as mentioned above. The theory is that in a set of replicate measurements of a physical or chemical quantity, one or more of the obtained values may differ considerably from the majority of the rest. In this case, a strong motivation always exists to eliminate those deviant values and not to include them in any subsequent calculation (e.g. of the mean value and/or of the standard deviation). This elimination is permitted only if the suspect values can be “legitimately” characterized as outliers.

Usually, an outlier is defined as an observation that is generated from a different model or a different distribution than was the main “body” of data. Although this definition implies that an outlier may be found anywhere within the range of observations, it is natural to suspect and examine as possible outliers only the extreme values.

The rejection of suspect observations must be based exclusively on objective criterion and not on subjective or intuitive grounds. This rejection can be achieved by using statistically sound tests for “the detection of outliers”.

The Dixon's Q-test is the simpler test of this type and is usually the only one described in textbooks of analytical chemistry in chapters of data treatment. This test allows examination if one (and only one) observation from a small set of replicate observations (typically 3 to 10) can be “legitimately” rejected.

Q-test is based on the statistical distribution of “sub range ratios” of ordered data samples, drawn from the same normal population. Hence, a normal (Gaussian) distribution of data is assumed whenever this test is applied. In case of the detection and rejection of an outlier, Q-test cannot be reapplied on the set of the remaining observations.

Application of the Q-test:

The test is applied as follows:
(1) The N values comprising the set of observations under examination are arranged in ascending order:

X₁<X₂<. . . <X_{N}

(2) The statistic experimental Q-value (Qₑₓₚ) is calculated. This ratio is defined as the difference of the suspect value from its nearest one divided by the range of the values (Q: rejection quotient). Thus, for testing x₁ or X_{N} (as possible outliers) we use the following Qₑₓₚ values:

$${Q}_{exp} = \frac{{X}_{2} - {X}_{1}}{{X}_{N} - {X}_{1}} \qquad {Q}_{exp} = \frac{{X}_{N} - {X}_{N - 1}}{{X}_{N} - {X}_{1}}$$

(3) The obtained Qₑₓₚ value is compared to a critical Q-value (Q_{crit}) found in tables. This critical value should correspond to the confidence level (CL) we have decided to run the test (usually: CL=95%).

(4) If Qₑₓₚ>Q_{crit}, then the suspect value can be characterized as an outlier and it can be rejected. If not, the suspect value must be retained and used in all subsequent calculations.

The null hypothesis associated to Q-test is as follows: “There is no a significant difference between the suspect value and the rest of them, any differences must be exclusively attributed to random errors.”

A table containing the critical Q values for CL 90%, 95% and 99% and N=3-10 is given below [from: D. B. Rorabacher, Anal. Chem. 63 (1991) 139]

Table of critical values of Q

| | Q_{crit} | Q_{crit} | Q_{crit} |
|---|---|---|---|
| N | (CL:90%) | (CL:95%) | (CL:99%) |
| 3 | 0.941 | 0.970 | 0.994 |
| 4 | 0.765 | 0.829 | 0.926 |
| 5 | 0.642 | 0.710 | 0.921 |
| 6 | 0.560 | 0.625 | 0.710 |
| 7 | 0.507 | 0.568 | 0.680 |
| 8 | 0.468 | 0.526 | 0.634 |
| 9 | 0.437 | 0.493 | 0.598 |
| 10 | 0.412 | 0.466 | 0.568 |

### 6. SHEET STRENGTH TEST

The tensile test is a mechanical stress-strain test measuring the tensile strength of a dough sheet. A dough strip is mounted by its ends onto the testing machine. The dough strip is elongated at a constant rate until the strip breaks. The force (g) at which the strip breaks is the tensile strength of the dough. The output of the tensile test is recorded as force/load versus distance/time. The sheet strength can be measured by the following method.

Equipment:

Stable Micro Systems Texture Analyzer TA-XT2 or TA-XT2i with 25 kg load cell capacity with Texture Expert Exceed Software and a 5 kg calibration weight.

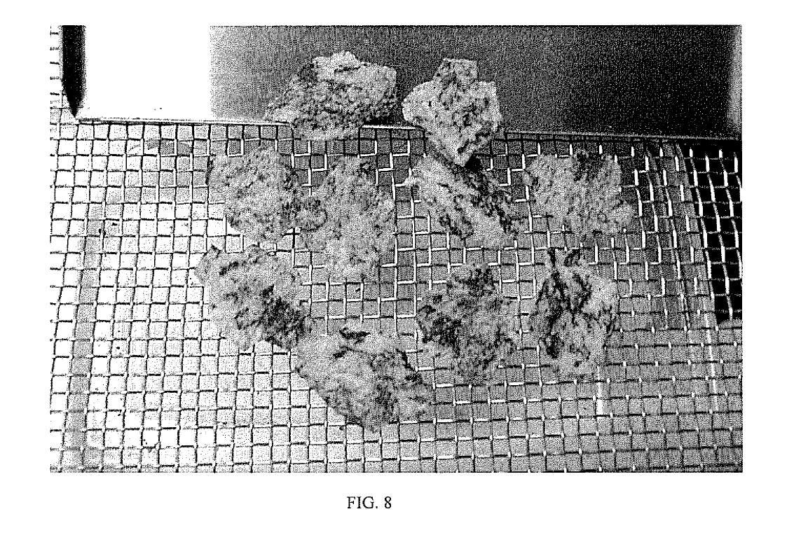

Instron Elastomeric Grips (Catalog # 2713-001), having the following replacement parts:
a. Internal springs (Instron Part No. 66-1-50) replaced with springs made from 0.5842 mm diameter wire. The replacement springs must be 3.81 cm long, have an inside diameter of 0.635 cm, and a K factor of 0.228 N/mm. Said replacement springs can be obtained from the Jones Spring Company of Wilder, Ky. U.S.A.; and
b. Instron Part No. T2-322 is replaced, as shown in FIGS. 8 and 9, by a modified roller plain. Said modified roller plain is an Instron Stock Part No. T2-322 that has been machined to have a flat side 4.412 cm long and 0.9525 cm wide on said roller plain's outer surface. Said flat side is covered with Armstrong Self-adhering Tape # Tap18230 and is positioned parallel to the sample side of the Grip's Clamp Frame Lower (Instron Part No. A2-1030). The Instron Elastomeric Grips are fixed on the top and bottom of the Texture Analyzer.

Sample Preparation:

1. Collect a dough sheet having a uniform thickness ranging from 0.38 mm to 2.50 mm and a length of at least 20 cm.

2. Cut samples from the dough sheet to form dough strips that are 2.5 cm wide and 15 cm long. The strips' 15 cm length should correspond to the dough's machine direction. Cut all of the strips sequentially.

3. Protect the samples from moisture loss by placing the samples in an air-tight container. The samples must be analyzed within 10 minutes of collection to ensure that the samples are analyzed fresh.

Texture Analyzer Settings:
Test Mode: Measure Force in Tension
Option: Return to Start
Pre-test speed: 3.0 mm/s
Test speed: 10 mm/s
Post test speed: 10 mm/s
Distance: 45 mm
Trigger Type: Auto
Trigger Force: 5 g
Units: grams
Distance: millimeters
Break Detect: Off

Data Analysis:

The sheet tensile strength for a sample is the maximum force before a sample breaks. A dough's sheet tensile strength is the average of five sample sheet strengths and recorded as gf (gram-force).

### 7. SERVING CALCULATIONS

The USDA has compiled a large database of food substances, ranging from raw fruit, vegetable, nuts, etc, as well as processed substances, such as canned tomatoes, and they also provide limited commercial products, such as Pop Tarts™. The searchable database can provide nutritional data on a weight basis whether as a whole small apple for example, or on a cup-basis as slices, etc. The website for the USDA Nutritional database is at http://www.nal.usda.gov/fnic/foodcomp/search.

To compute a serving of food substance, the following is done. A serving of fruit or vegetable can be provided by the same amount of dry solids as that would be found in a half-cup of the said material. Thus, for any particular food substance of interest, a search is done in the USDA database and a weight obtained on a per cup basis. Selecting the nutritional data output on a 100 gram basis would provide the data as a percentage. The data lists the water content of the material on a 100 gram basis so the percentage of solids would be equal to 100 minus the water content. Therefore, a serving is calculated by dividing the cup weight obtained earlier by two to obtain a half-cup value and multiplying that by the percentage of dry solids obtained from the nutritional section.

For example: searching “apples raw without skin” the database 09004 Malus domestica will show a cup of apple slices as weighing 110 grams and has a water content of 86.67 grams per 100 grams of edible portion, or 86.67%. The amount of solids would be equal to 100−86.67=13.33% solids. A serving basis (S.B.) is therefore: 110 g/2=55 grams×13.33% =7.33 grams.

Following this basis, it is therefore understood that a serving of fruit, for example, can formulated from a mixture of fruits, where the amount of fruit solids needed is based upon the percentage of each fruit and its requisite amount of respective solids. For example, a 90% apple and 10% peach product would require the following amount of respective solids:

90% apple×7.33 gm S.B. (from example above)=6.597 grams 10% peach×8.57 gm S.B. (as determined following protocol established above)=0.857 grams

Note that one serving of fruit comprising 90:10 apple/peach requires a total of 7.454 grams, whereas one serving of fruit from 100% apple requires 7.33 grams.

The basis for determining the amount of fruit or vegetable servings within a formulated finished snack follows. The food substances of interest should be determined as a percentage of the finished consumable snack multiplied by the serving size of the snack item, e.g., one ounce, divided by the S.B. For example, if the apple solids comprises 27.3% of the final product, and a serving size is one ounce, then 28.375 grams×27.3%=7.75 grams divided by 7.33 grams (S.B. from example above)=1.057 servings of apple per ounce of finished chips. In determining the percentage of the food substances of interest in the final product, every ingredient used in formulating the product on a wet basis should be calculated as to its contribution on a bone-dry basis. References should be cited as to how the dry basis was obtained, for example, by actual analysis, or from supplier specifications, or from a database of values. Further, the percentage of the food substances of interest in the final product should be adjusted by the moisture content, which also comprises the final product of commerce.

An apple chip example follows:
The formulated product dough and the resultant ingredient percentage on a bone dry basis of the base chip are provided in the table below. Note that supplier's percent solids obtained from the RMS sheets were used in these calculations.

| | | | % | | |
|---|---|---|---|---|---|
| | Batch wt | | solids | Batch wt | % |
| | (gms) | Percent | from | (gms) | b.d. |
| Ingredient | 200.00 | (wet basis) | RMS | dry. basis | basis |
| Apple puree | 107.45 | 53.73 | 32 | 34.38 | 28.70 |
| Concentrate | | | | | |
| Vegetable Oil | 5.75 | 2.88 | 100 | 5.75 | 4.80 |
| Canola | | | | | |
| Whole Grain Oats | 10.74 | 5.37 | 90 | 9.66 | 8.07 |
| Flour | | | | | |
| Sugar (granulated) | 3.48 | 1.74 | 99.9 | 3.48 | 2.90 |
| Cinnamon | 1.39 | 0.70 | 90.5 | 1.26 | 1.05 |
| Pregel Rice flour, | 30.51 | 15.26 | 91 | 27.77 | 23.17 |
| white | | | | | |
| Pregel Wheat Starch | 15.26 | 7.63 | 91 | 13.88 | 11.59 |
| Tistar tapioca | 25.42 | 12.71 | 93 | 23.64 | 19.73 |
| Totals | 200.00 | 100 | | 119.83 | 100.00 |

Final Product of Commerce Composition:

| | |
|---|---|
| Base Chip (from above) | 90% |
| Oil spray for seasoning adhesion | 2% |
| Topical seasoning | 6% |
| Moisture | 2% |

Since only the base chip is providing the source of fruit comprising the final product, the calculation becomes:
Serving of Fruit=90% base chip in product of commerce×28.375 gms/ounce=25.538 g 25.538 g×28.7% apple solids in base chip=7.33 g of apple solids. 7.33 g of apple solids provided by product of commerce/7.33 g S.B.=1.0 serving basis.

### G. EXAMPLES

Particular embodiments of the present invention are illustrated by the following non-limiting examples.

Table 1 lists the composition and respective amounts for four apple based snacks in accordance with embodiments of the present invention.

Example 1 is an apple oatmeal snack chip.

An apple-oatmeal chip is made by first grinding tapioca such that it passes through a US #30 mesh sieve. The oats are hydrated with a portion of the water (how much water) and microwaved. The apple powder is then hydrated with a portion of the water, and both the hydrated oats and hydrated apple powder are mixed in a mixer. Salt, cinnamon, Splenda, butter flavor, and sugars were blended to form a dry pre-blend. The dry pre-blend is slowly added to the apple/oat mixture and mixed for about 1 minute. The starch is slowly added and the ingredients are mixed for approximately 1 minute. The remaining water is heated and added. Mixing is continued for approximately 2 additional minutes. The total mixture is placed into a Cuisinart® mixer and mixed for approximately 30 seconds until starch is completely blended and a dough is formed.

The dough is then rolled, using a rolling pin, between wax paper to a thickness of from about 0.035 to about 0.040 inches. Circles approximately 2 inches in diameter are cut from the sheeted dough. The circles are placed on stainless steel trays place in Lang forced air oven (Lang Manufacturing Co. 6500 Merrill Creek Parkway, Everett, Wash. 98203-5860) at about 200 F and dried to a moisture of about 10%, and the water activity is less than about 0.6 to produce a half product.

The half product is finished by baking in a Holman Miniveyor conveyor oven (Star Manufacturing International, Inc., 10 Sunnen Drive, P.O. Box 430129, St. Louis, Mo. 63143-3800) Model 210HX Oven with a conveyor speed of about 1.0 minute. An ancillary temperature probe placed about one third of the way centered into the oven and about one and a half inches above the conveyor belt showed an oven temperature of about 350 F. The final product had a crispy texture with a good apple taste.

Alternatively, the baking can be at about 325 F for about 1.5 to about 1.75 minutes in a convection oven. The final product had water activity of about 0.3.

TABLE 1
EXAMPLE Nos. 1-4

| | | 1 | 1 | | 2 | 3 | 3 | 4 | 4 |
|---|---|---|---|---|---|---|---|---|---|
| | | Wet | Dry | 2 | Dry | Wet | Dry | Wet | Dry |
| | | Wt. | Wt. | Wet | Wt. | Wt. | Wt. | Wt. | Wt. |
| Ingredients | Mfg. and Ref # | % | % | Wt. % | % | % | % | % | % |
| One Minute | Quaker 100% | 11 | 18.3 | 0 | 0 | 11 | 18.3 | 5.4 | 9.1 |
| Oats | Whole Grain | | | | | | | | |
| | Mar0307L108 | | | | | | | | |
| Water | Milli Pore | 40.1 | 0 | 43.6 | 0 | 40.1 | 0 | 41 | 0 |
| Whole | Agvest/Nigara | 15.1 | 25.2 | 19.1 | 33.9 | 15.1 | 25.2 | 15 | 25.2 |
| Apple | 425175-03 A- | | | | | | | | |
| Powder | 120 | | | | | | | | |
| Salt | Mortons 1 | 0.47 | 0.79 | 0.44 | 0.79 | 0.47 | 0.79 | 0.5 | 0.79 |
| | 7B5BA1 non | | | | | | | | |
| | iodized | | | | | | | | |
| Cinnamon | Krogers | 1.36 | 2.27 | 1.28 | 2.27 | 1.36 | 2.27 | 1.3 | 2.27 |
| | Ground Aug | | | | | | | | |
| | 09 08GB | | | | | | | | |
| Splenda | McMeil | 1.29 | 2.15 | 1.21 | 2.15 | 1.69 | 2.83 | 1.3 | 2.15 |
| | Nutritionals | | | | | | | | |
| | PPC 72460 | | | | | | | | |
| | 8724611 | | | | | | | | |
| Butter | Butter Buds | 0.14 | 0.23 | 0.13 | 0.23 | 0.14 | 0.23 | 0.1 | 0.23 |
| Flavor | TPK213A | | | | | | | | |
| Granules | Cumberland | | | | | | | | |
| | Packing Co | | | | | | | | |
| Dark Brown | Domino 49200 | 1.72 | 2.87 | 1.62 | 2.87 | 0 | 0 | 1.7 | 2.87 |
| Sugar | 05791 | | | | | | | | |
| Domino | Domino 04- | 1.63 | 2.73 | 1.54 | 2.73 | 0 | 0 | 1.6 | 2.73 |
| Sugar | 655302-11/03 | | | | | | | | |
| Tapioca | Kraft KFI | | | | | | | | |
| Starch <30 | 11800 80000 | 27.2 | 45.46 | 31.1 | 55.1 | 30.2 | 50.4 | 32 | 54.6 |
| mesh | | | | | | | | | |

Example 5 is an apple and oatmeal chip that includes native potato starch (not gelatinized) in addition to pre-gelatinized tapioca starch. The amounts of ingredients for Example 5 are listed in Table 2.

TABLE 2
EXAMPLE No. 5

| | | 5 | 5 |
|---|---|---|---|
| | | Wet | Dry |
| Ingredients | Mfg. and Ref # | Wt. % | Wt. % |
| One Minute | Quaker 100% Whole Grain | 10.95 | 18.29 |
| Oats | Mar0307L108 | | |
| Water | Milli Pore | 40.14 | 0.00 |
| Whole Apple | Agvest/Nigara 425175-03 A- | 15.08 | 25.20 |
| Powder | 120 | | |
| Salt | Mortons 1 7B5BA1 non | 0.47 | 0.79 |
| | iodized | | |
| Cinnamon | Korgers Ground Aug 09 | 1.36 | 2.27 |
| | 08GB | | |
| Splenda | McMeil Nutritionals PPC | 1.29 | 2.15 |
| | 72460 8724611 | | |
| Butter Flavor | Butter Buds TPK213A | 0.14 | 0.23 |
| Granules | Cumberland Packing Co | | |
| Dark Brown | Domino 49200 05791 | 1.72 | 2.87 |
| Sugar | | | |
| Domino Sugar | Domino 04-655302-11/03 | 1.63 | 2.73 |
| Tapioca Starch | Kraft KFI 11800 80000 | 19.05 | 31.83 |
| <30 mesh | Avebe Native Potato Starch* | 8.16 | 13.64 |
| Potato Starch | | | |

*Not pre-gelatinized

Examples 6-10

The following examples are embodiments of the invention using a puree. It is believed that in each example at least one of, or all of, the oil ingredient, the oat flour ingredient, the sugar ingredient, and the cinnamon ingredient are optional ingredients that are added for desired taste.

Drying in the following examples can be done by a two stage process. In the first stage, dough pieces are baked in a two zone direct baking process for about two minutes. The first zone is set at about 500° F. for about one minute, and the second zone is set at about 400° F. for about one minute. In the second stage, the product is dried at about 250° F. for about 15 minutes. Depending on the actual properties of the dough pieces and the characteristics of the oven, the actual times to finish drying may be more or less than the above in order to prepare a desired snack chip.

Example 6 is an apple and oatmeal chip prepared using an apple puree. The rice, wheat, tapioca, oats, sugar, and cinnamon are pre-blended by adding them to a pilot-scale Shaffer™ single Sigma mixer and allowed to mix on low speed for one minute. The vegetable oil is added by spraying the oil into the mixer while mixing on high speed for one minute. All of the oil is added during the first 15 seconds of this mixing step by weighing the oil into a tank sprayer and pressurizing the cylinder with air or nitrogen, allowing the oil to spray through a spray nozzle into the mixer. Finally, the apple puree is added and allowed to mix on high speed for one minute. The dough is sheeted to a nominal 0.035 inch thickness using gauging rolls. Individual chip pieces are cut from the sheeted dough and then dried. Table-3 provides the ingredients on a formulated basis and on a bone dry (b.d.) basis.

TABLE 3
Example No. 6

| | | Batch wt (lbs) | Percent | Percent |
|---|---|---|---|---|
| Ingredient | Supplier | 200.00 | (wet basis) | b.d. basis |
| Apple puree Concentrate @ | SVC-USA | 107.45 | 53.73 | 28.70 |
| 32° B | Crisco ™ | | | |
| Vegetable Oil | Canola Oil | 5.75 | 2.88 | 4.80 |
| Whole Grain Oat Flour | Grain Miller | 10.74 | 5.37 | 8.07 |
| Sugar (granulated) | Domino ™ | 3.48 | 1.74 | 2.90 |
| Cinnamon (ground) | Tones ™ | 1.39 | 0.70 | 1.05 |
| Pre-gelatinized Rice flour, white | Sage V | 30.51 | 15.26 | 23.17 |
| | Foods | | | |
| Pre-gelatinized Wheat Starch | Gem Of The | 15.26 | 7.63 | 11.59 |
| | West | | | |
| Pre-gelatinized tapioca | Tistar | 25.42 | 12.71 | 19.73 |
| Totals | | 200.00 | 100.00 | 100.00 |

Example 7 is a mixed berry variegated chip prepared using purees. Table-4 provides the final composition on a formulated basis and on a bone dry basis. In preparing the variegated chip, the first dough is prepared by adding the strawberry puree, raspberry puree, acerola juice, and lemon juice to a stockpot, blended well with a spatula, and allowed to stand. To a large Hobart™ mixing bowl are added 15% of the stated values for rice, wheat, tapioca, and oats and allowed to mix for 1 minute on speed 2 using the whisk attachment. One-half of the stated oil is added to the Hobart™ and mixed for 1 minute on speed-3. The pre-blended puree & juice mixture is added to the Hobart™ and mixed for 10 seconds on speed-4. The bowl is scraped down and hand mixed using a spatula to ensure no dry ingredients remain in the bottom of the Hobart™ bowl. The dough is mixed for an additional 10 seconds on speed-4. The second dough is prepared by adding 85% of the stated values for the rice, wheat, tapioca, and oats, to a pilot-scale Shaffer™ single Sigma mixer. All of the sugar and cinnamon are then added and pre-blended by mixing on low speed for one minute. One half of the stated vegetable oil is then added by spraying the oil into the mixer while mixing on high speed for one minute by weighing the oil into a tank sprayer and pressurizing the cylinder with air or nitrogen, allowing the oil to spray through a spray nozzle into the mixer. The apple puree is added, and allowed to mix on high speed for one minute. The first dough from the Hobart™ mixer is added to the second dough in the Shaffer mixer and mixed on high speed for one minute. The resultant commingled dough is sheeted to a nominal 0.035 inch thickness using gauging rolls. Individual chip pieces are cut from the sheeted dough and then dried. Picture 3 is a representation of a chip.

TABLE 4
Example No. 7

| | | Batch wt | | Percent |
|---|---|---|---|---|
| | | (lbs) | Percent | b.d. |
| Ingredient | Supplier | 200.00 | (wet basis) | basis |
| Strawberry Puree | Milne Fruit Products Inc. | 6.43 | 3.21 | 1.48 |
| concentrate @ 28° B | | | | |
| Raspberry Puree | Milne Fruit Products Inc. | 7.52 | 3.76 | 1.73 |
| concentrate @ 28° B | | | | |
| Apple puree Concentrate @ | SVC-USA | 95.16 | 47.58 | 25.92 |
| 32° B | | | | |
| Vegetable Oil | Crisco ™ Canola Oil | 5.40 | 2.70 | 4.59 |
| Whole Grain Oat flour | Grain Miller | 6.51 | 3.26 | 4.99 |
| Sugar (granulated) | Domino ™ | 4.00 | 2.00 | 3.40 |
| Lemon Juice Concentrate @ | Phoenix Fruit Concentrates | 1.56 | 0.78 | 0.67 |
| 50° B | | | | |
| Acerola Juice | ITI Tropical | 0.39 | 0.20 | 0.22 |
| Concentrate @ 65° B | | | | |
| Pre-gelatinized Rice flour, | Sage V Foods | 31.46 | 15.73 | 24.37 |
| white | | | | |
| Pre-gelatinized Wheat | Gem Of The West | 15.66 | 7.83 | 12.13 |
| Starch | | | | |
| Pre-gelatinized tapioca | Tistar ™ | 25.92 | 12.96 | 20.51 |
| Totals | | 200.00 | 100.00 | 100.00 |

Example 8 is an apple and oatmeal chip prepared using both an apple puree and apple powder. The rice, wheat, tapioca, oats, apple powder, sugar, and cinnamon are pre-blended by adding them to a pilot-scale Shaffer™ single Sigma mixer and allowed to mix on low speed for one minute. The vegetable oil is added by spraying the oil into the mixer while mixing on high speed for one minute. All of the oil is added during the first 15 seconds of this mixing step by weighing the oil into a tank sprayer and pressurizing the cylinder with air or nitrogen, allowing the oil to spray through a spray nozzle into the mixer. Finally, the apple puree is added and allowed to mix on high speed for one minute. The dough is sheeted to a nominal 0.035 inch thickness using gauging rolls. Individual chip pieces are cut from the sheeted dough and then dried. Table-5 provides the ingredients on a formulated basis and on a bone dry basis.

TABLE 5
Example No. 8

| | | Batch wt | Percent | |
|---|---|---|---|---|
| | | (lbs) | (wet | Percent |
| Ingredient | Supplier | 200.00 | basis) | b.d. basis |
| Apple puree | SVC-USA | 92.62 | 46.31 | 22.96 |
| Concentrate @ | | | | |
| 32° B | | | | |
| Apple Powder | Niagara Foods Inc. | 7.67 | 3.83 | 5.74 |
| | Inc. | | | |
| Vegetable Oil | Crisco ™ Canola | 6.20 | 3.10 | 4.80 |
| | Oil | | | |
| Whole Grain | Grain Miller | 11.57 | 5.78 | 8.07 |
| Oat Flour | | | | |
| Sugar | Domino ™ | 3.75 | 1.88 | 2.90 |
| (granulated) | | | | |
| Cinnamon | Tones ™ | 1.50 | 0.75 | 1.05 |
| Pre-gelatinized | Sage V Foods | 32.87 | 16.44 | 23.17 |
| Rice flour, | | | | |
| white | | | | |
| Pre-gelatinized | Gem Of The | | | |
| Wheat | West | 16.44 | 8.22 | 11.59 |
| Starch | | | | |
| Pre-gelatinized | Tistar ™ | 27.38 | 13.69 | 19.73 |
| tapioca | | | | |
| Totals | | 200.00 | 100.00 | 100.00 |

Example 9 is a Corn-Pepper chip prepared using both a pepper puree and corn powder. The rice, wheat, tapioca, oats, and corn powder are pre-blended by adding them to a pilot-scale Shaffer™ single Sigma mixer and allowed to mix on low speed for one minute. The vegetable oil is added by spraying the oil into the mixer while mixing on high speed for one minute. All of the oil is added during the first 15 seconds of this mixing step by weighing the oil into a tank sprayer and pressurizing the cylinder with air or nitrogen, allowing the oil to spray through a spray nozzle into the mixer. Finally, the red bell pepper puree is added and allowed to mix on high speed for one minute. The dough is sheeted to a nominal 0.035 inch thickness using gauging rolls. Individual chip pieces are cut from the sheeted dough and then dried. Table-6 provides the ingredients on a formulated basis and on a bone dry basis.

TABLE 6
Example No. 9

| | | Batch wt | Percent | Percent |
|---|---|---|---|---|
| | | (lbs) | (wet | b.d. |
| Ingredient | Supplier | 200.00 | basis) | basis |
| Red Bell Pepper | Vegetable Juices Inc. | 86.80 | 43.40 | 5.32 |
| Puree | | | | |
| Corn Powder | Silva International | 66.00 | 33.00 | 56.54 |
| Vegetable Oil | Crisco ™ Canola Oil | 2.20 | 1.10 | 2.00 |
| Whole Grain Oat | Grain Miller | 7.40 | 3.70 | 5.91 |
| Flour | | | | |
| Pregelatinized | Sage V Foods | 16.20 | 8.10 | 12.94 |
| Rice flour, white | | | | |
| Pregelatinized | Gem Of The West | 8.00 | 4.00 | 6.50 |
| Wheat Starch | | | | |
| Pre-gelatinized | Tistar ™ | 13.40 | 6.70 | 10.79 |
| tapioca | | | | |
| Totals | | 200.00 | 100.00 | 100.00 |

Example 10 is a Broccoli chip prepared using both a broccoli puree and broccoli powder. The rice, wheat, tapioca, oats, and broccoli powder are pre-blended by adding them to a pilot-scale Shaffer™ single Sigma mixer and allowed to mix on low speed for one minute. The vegetable oil is added by spraying the oil into the mixer while mixing on high speed for one minute. All of the oil is added during the first 15 seconds of this mixing step by weighing the oil into a tank sprayer and pressurizing the cylinder with air or nitrogen, allowing the oil to spray through a spray nozzle into the mixer. Finally, the broccoli puree is added and allowed to mix on high speed for one minute. The dough is sheeted to a nominal 0.035 inch thickness using gauging rolls. Individual chip pieces are cut from the sheeted dough and then dried. Table-7 provides the ingredients on a formulated basis and on a bone dry basis.

TABLE 7
Example No. 10

| | | Batch | | Percent |
|---|---|---|---|---|
| | | wt (lbs) | Percent | b.d. |
| Ingredient | Supplier | 200.00 | (wet basis) | basis |
| Broccoli Puree | Vegetable Juices | 75.28 | 37.64 | 5.00 |
| | Inc. | | | |
| Broccoli Powder | FDP-USA | 15.06 | 7.53 | 12.40 |
| Vegetable Oil | Crisco ™ Canola Oil | 6.34 | 3.17 | 5.32 |
| Whole Grain Oat | Grain Miller | 15.34 | 7.67 | 11.47 |
| Flour | | | | |
| Pregelatinized | Sage V Foods | 42.14 | 21.07 | 31.54 |
| Rice flour, white | | | | |
| Pregelatinized | Gem Of The West | 19.00 | 9.50 | 14.20 |
| Wheat Starch | | | | |
| Pre-gelatinized | Tistar | 26.84 | 13.42 | 20.07 |
| tapioca | | | | |
| Totals | | 200.00 | 100.00 | 100.00 |

### Picture No. 1

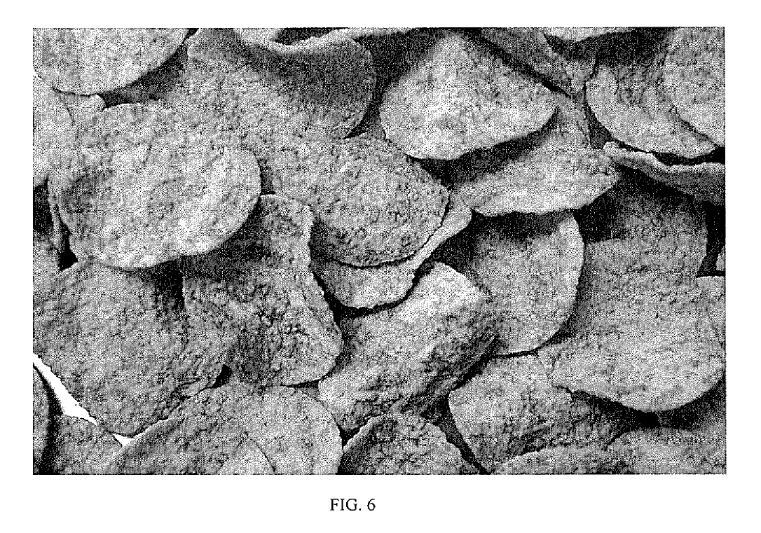

An apple-cherry variegated chip made without lemon juice & acerola is shown in FIG. 6.

### Picture No. 2

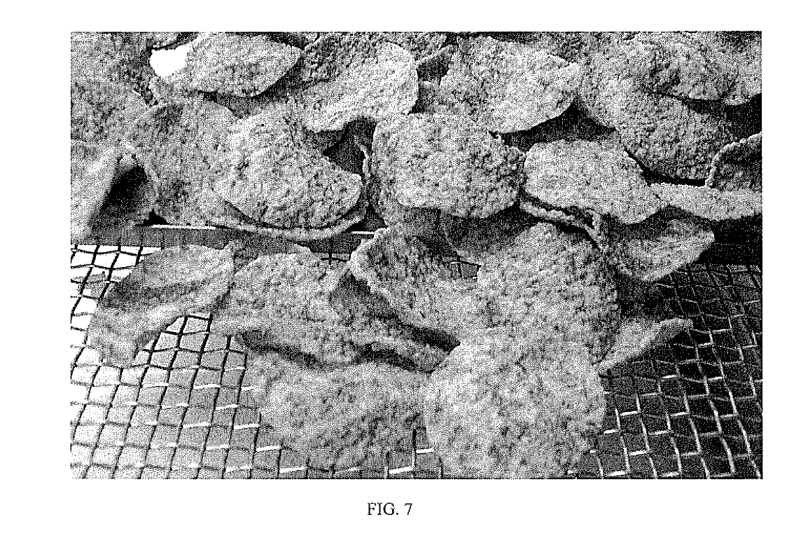

An apple-cherry variegated chip made with added lemon juice & acerola is shown in FIG. 7.

### Picture No. 3

A mixed berry variegated chip prepared according to Example No. 7 is shown in FIG. 8.

H. PACKAGING

The snack chips herein described can be packaged and sold to consumers. Such packaging can be of various forms and can generally be any package that is configured to deliver snack chips to a consumer, including bags of all shapes and sizes, canisters, multi-packs of bags contained within another container, cardboard or paperboard (paper-based) containers, and combinations and mixtures thereof. For example, a bag-based package could be used as a primary package for containing the snack chips, and several bag-based package could be combined with a secondary package, such as a paper-based package. Any and all combinations and mixtures can be envisioned. Such combinations can be used, for example, when providing a single serving of chips in a single package and then combining several single serving packages within a larger package.

In one embodiment, a packaging system defining an interior volume and having an outer panel visible to a consumer while in a customary position on a retail store shelf is disclosed. An outer portion of the package can contain a label that is visible by consumer when shopping in a retail store. The label can include a statement declaring that one full serving of fruit of vegetable is contained by, or delivered by, a product contained within the package. Such product can be any of the products as described herein. The full serving of fruit or vegetable is defined by the USDA or any other governmental authority. Contained within the package can be a plurality of fabricated snack chips as described herein. These fabricated snack chips can deliver one full serving of fruit of vegetable per one full serving of fabricated snack chips, which is presently 28-30 g grams per one ounce fabricated snack chips.

In another embodiment, an ingredient list can be displayed on the package and can be displayed on the panel that is visible to a consumer while in a customary position on a retail store shelf. The ingredient list can comprise a listing of ingredients contained in the product contained inside the package. Ingredient listings are well known in the art and are regulated by the governing bodies of the United States government, including the FDA. It is envisioned that the ingredient listings described herein are consistent with the food labeling regulations set forth by the FDA. The ingredient list of ones embodiment can have as its first ingredient a fruit or vegetable. Other embodiments can have the first two ingredients a fruit or a vegetable. Still other embodiments can have two of the first three ingredients a fruit or a vegetable. Thus, the plurality of fabricated snack chips contained within the package can have, as their predominant ingredient, a fruit, or a vegetable.

Any number of servings of fruit or vegetable can be included inside the package, including from 1 to about 8 and all numbers therebetween.

In yet another embodiment, a kit is disclosed. The kit can comprise a package and a plurality of fabricated snack chips. The plurality of fabricated snack chips can be contained within the package. The package, as above, can be any suitable package for delivery of fabricated snack chips. The package can have a label containing a statement declaring that one full serving of fruit or vegetable is delivered by the fabricated snack chips. The package can further have an ingredient list displayed, as hereinabove described. The ingredient list can contain a listing of the ingredients of the fabricated snack chips contained therein and again can be consistent with the USFDA food labeling regulations. The ingredient list can have as its first and thus most predominant ingredient a fruit or a vegetable. Thus, because of the one full serving of fruit or vegetable statement on the label, and the ingredient list having as the first ingredient a fruit or a vegetable, the fabricated snack ships contained inside of the container can be such that they contain one full serving of fruit or vegetable per one full serving of fabricated snack chips and also have as their most predominant ingredient a fruit or a vegetable. The bag can be of any color, including green, which is not heretofore been recognized as a desirable color for snack chip bags. Moreover, colors that represent or connote the fruit or vegetable being delivered by the snack chip can be used. For example, a green package may be used for an apple chip. Or a red-ish or orange-ish package can be used to deliver a peach chip.

### INCORPORATION BY REFERENCE

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A snack chip comprising fruit source solids or vegetable source solids and wherein the snack chip comprises less than about 12% fat.

2. A plurality of snack chips according to claim 1 and wherein at least one half of a serving of fruit or at least one half of a serving of vegetable is provided by one serving of snack chips.

3. A plurality of snack chips according to claim 1 and wherein one serving of fruit or one serving of vegetable is provided by one serving of snack chips.

4. The snack chip of claim 1, and wherein the snack chip has a water absorption value of less than 2.5.

5. The snack chip of claim 1 and wherein the chip is made by:
a) combining dry ingredients with water to form a dough;
b) sheeting the dough;
c) cutting the dough into pieces;
d) drying the pieces into a half product;
e) baking the half product into the snack chip.

6. A snack, comprising:
a) from about 12% to about 66% of fruit source solids;
b) from about 34% to about 88% of starch material;
c) from about 0.1% to about 5.0% of water; and
d) from about 0% to about 54% of optional ingredients.

7. The snack chip of claim 6 and wherein the starch material comprises rice.

8. The snack chip of claim 6 and wherein the starch material comprises tapioca.

9. The snack chip of claim 6 and wherein the starch material comprises rice and tapioca.

10. The snack chip of claim 6 and further comprising oatmeal.

11. The snack chip of claim 6 and wherein the snack chip comprises less than 12% fat.

12. A plurality of snack chips according to claim 6 and wherein a plurality of snack chips delivers one serving of fruit per one serving of snack chip.

13. The snack chip of claim 6 and wherein the snack chip comprises less than 12% fat and wherein one serving of the snack chips delivers one serving of fruit.

14. The snack chip of claim 6 and wherein the snack chip has a water absorption between about 1.5 and about 2.5.

15. The snack chip of claim 6 and wherein the snack chip has a fracture strength of from about 100 gf to about 700 gf.

16. A dough for use in preparing a snack chip, comprising:
a) from about 20% to about 81% of fruit puree;
b) from about 15% to about 50% pre-gelatinized starch material;
c) from about 0% to about 65% optional ingredients.

17. The dough of claim 16 and wherein the pre-gelatinized starch material comprises rice.

18. The dough of claim 16 and wherein the pre-gelatinized starch material comprises tapioca.

19. The dough of claim 16 and wherein the pre-gelatinized starch material comprises rice and tapioca.

20. The dough of claim 16 and wherein the optional ingredients comprise oatmeal and water.

21. A method for making a snack chip, comprising:
a) forming a dough by mixing:
1. 7% to 50% of fruit source solids;
2. 12% to 50% of pre-gelatinized starch material; and
3. 0% to 81% of optional ingredients;
b) forming the dough into a thin sheet;
c) forming the thin sheet into a snack chip; and
d) drying the snack chip to a moisture content of between about 0.3% and 3%.

22. The method of claim 21, wherein the drying step comprises at least a first stage and a second stage, wherein the first stage comprises drying the thin sheet to a half product having a moisture content of between about 4% and 16%, and wherein the second stage comprises drying the half product to a moisture content of between about 0.3% and 3%.

23. The method of claim 21, wherein the drying is achieved at atmospheric pressure.

24. The method of claim 21, wherein the forming of a dough into a thin sheet comprises at least of one of milling, gauging, rotary molding, and non-heat extrusion.

25. The method of claim 21, wherein the pre-gelatinized starch material comprises tapioca.

26. The method of claim 25, wherein the tapioca is less than 100% gelatinized.

27. The method of claim 21, wherein the forming the thin sheet into a snack chip comprises cutting out of the thin sheet of dough a desired size and shape of the snack chip prior to the drying.

28. The method of claim 21, wherein said fruit source solids is prepared by maceration of fresh fruit.
